(19) United States
(12) Patent Application Publication
(10) Pub. No.: US 2026/0326776 A1
(43) Pub. Date: Oct. 22, 2026

(54) TEST SYSTEM, TEST METHOD, AND SOFTWARE MANAGEMENT DEVICE

(71) Applicant: DENSO CORPORATION, Kariya-city (JP)

(72) Inventors: Atsushi BABA, Kariya-city (JP); Takuya KUME, Kariya-city (JP); Kazuki IZUMI, Kariya-city (JP)

(21) Appl. No.: 19/700,537

(22) Filed: Jun. 8, 2026

Related U.S. Application Data
(63) Continuation of application No. PCT/JP2024/040455, filed on Nov. 14, 2024.

(30) Foreign Application Priority Data
Dec. 11, 2023 (JP) 2023-208762

(51) Int. Cl. B60W 50/04; G06F 8/61

(52) U.S. Cl. CPC B60W 50/04; G06F 8/61; B60W 2050/041

(57) ABSTRACT

A management system functioning as a test system tests, using one or more vehicles capable of participating in open road traffic, a driving system as a vehicle system mounted on the vehicle. The management system includes a test conduction unit that sets and conducts a test, and a test stop unit that has both an individual stop functionality of individually stopping the test in a participation unit and an overall stop functionality of stopping the test as a whole in a standby-ready state or a conduction state of the test.

### CROSS-REFERENCE TO RELATED APPLICATIONS

The present application is a continuation application of International Patent Application No. PCT/JP2024/040455 filed on Nov. 14, 2024, which designated the U.S. and claims the benefit of priority from Japanese Patent Application No. 2023-208762 filed on Dec. 11, 2023. The entire disclosures of all of the above applications are incorporated herein by reference.

### TECHNICAL FIELD

The disclosure in the present disclosure relates to a technique for testing a vehicle system.

### BACKGROUND

There has been known a technique for testing, using a vehicle participating in open road traffic, a vehicle system mounted on the vehicle.

### SUMMARY

According to an aspect of the present disclosure, a test system for testing a vehicle system is provided. The vehicle system is mounted on each of one or more vehicles that are allowed to participate in open road traffic. The test system includes at least one processor with a memory storing computer program code, and the at least one processor with the memory is configured to set and conduct a test. The at least one processor may have both (i) an individual stop functionality for individually stopping the test in a participation unit in a standby-ready state or a conduction state of the test and an (ii) overall stop functionality for stopping the test as a whole in the standby-ready state or the conduction state of the test.

### BRIEF DESCRIPTION OF DRAWINGS

The present disclosure will become apparent from the following detailed description made with reference to the accompanying drawings. In the drawings:

FIG. 1 is a diagram illustrating an example of a hardware configuration of a driving system or the like;

FIG. 2 is a diagram illustrating a functional configuration of the driving system;

FIG. 3 is a diagram illustrating an example of a configuration of a cockpit;

FIG. 4 is a diagram illustrating an outline of a management system;

FIG. 5 is a diagram illustrating a functional configuration of the management system;

FIG. 6 is a flowchart illustrating a process related to a test;

FIG. 7 is a flowchart illustrating a process related to a test;

FIG. 8 is a flowchart illustrating a process related to a test;

FIG. 9 is a flowchart illustrating a process related to a test;

FIG. 10 is a flowchart illustrating a process related to a test;

FIG. 11 is a flowchart illustrating a process related to a test;

FIG. 12 is a diagram illustrating an example of a notification using an HMI;

FIG. 13 is a flowchart illustrating a process related to a test;

FIG. 14 is a diagram illustrating an example of a notification using the HMI;

FIG. 15 is a diagram illustrating an example of a notification using the HMI;

FIG. 16 is a flowchart illustrating a process related to a test;

FIG. 17 is a flowchart illustrating a process related to a test;

FIG. 18 is a diagram illustrating an example of a hardware configuration of a processing system; and

FIG. 19 is a diagram illustrating an example of a hardware configuration of the processing system.

### DETAILED DESCRIPTION

As well known, vehicle systems has become complicated recent years, and in order to cope with the complicated system, the importance of providing the V&V process to the vehicle after coming on the market is increased. In the vehicle system test using the vehicle participating in open road traffic, consideration of methods for stopping the test may be a new problem, from the viewpoint of validity and usability of a test operation.

According to an aspect of the present disclosure, a test system for testing a vehicle system is provided. The vehicle system is mounted on each of one or more vehicles that are allowed to participate in open road traffic. The test system includes a test conduction unit configured to set and conduct a test, and a test stop unit having both an individual stop functionality for individually stopping the test in a participation unit in a standby-ready state or a conduction state of the test and an overall stop functionality for stopping the test as a whole in the standby-ready state or the conduction state of the test.

According to such an aspect, the individual stop functionality and the overall stop functionality of the participation unit can be selectively used. Therefore, the test can be stopped in an appropriate form in consideration of the validity and usability of the test operation.

According to another aspect of the present disclosure, a test method for testing a vehicle system is provided. The vehicle system is mounted on each of multiple vehicles that are allowed to participate in open road traffic. The test method includes determining, in each of the multiple vehicles, whether to enable an individual stop functionality that stops a test for one or more individual vehicles among the multiple vehicles by using one or more metrics, and determining, based on a situation of the individual stop functionality being enabled in the one or more individual vehicles, whether to enable an overall stop functionality that stops the test for all of the multiple vehicles.

According to such an aspect, it is determined whether to individually stop the test using a metric in a vehicle unit. Further, it is determined whether to stop the test as a whole based on the situations of the multiple vehicles. Thus, the test can be stopped in an appropriate form by determining the stop functionality stepwise in above-described manner.

According to another aspect of the present disclosure, a software management device for managing software used in a vehicle system is provided. The software is used to test the vehicle system mounted on each of one or more vehicles that are allowed to participate in open road traffic. The software management device includes at least one processor with a memory storing computer program code. The at least one processor with the memory is configured to: download, in a standby-ready state of a test, test software from a server and store in hardware of the vehicle system separately from conventional software; cause both the conventional software and the test software to remain in the hardware with one or both of the conventional software or the test software being in a ready to be enabled state; and when a specific vehicle, which is one of the one or more vehicles equipped with the vehicle system, stops the test, enable the conventional software and disable the test software while remaining both the conventional software and the test software in the hardware.

According to such an aspect, when the vehicle stops the test, software for the test remains in the hardware provided in the vehicle system. Therefore, the test can be easily resumed. The state of the software during conduction of the test is stored. Thus, the test can be easily verified later. Therefore, the test can be stopped in an appropriate form.

Hereinafter, multiple embodiments will be described based on the drawings. Duplicate description may be omitted by assigning the same reference numerals to the corresponding elements in each embodiment. When only a part of a configuration is described in each embodiment, the configurations of the other embodiments described above can be applied to the other parts of the configuration. In addition, configurations specified in the description of each embodiment can be combined, and especially, configurations of multiple embodiments can be partially combined even though not specified here so long as no problem occurs in the combination thereof.

In the following multiple embodiments, the contents of “Safety First for Automated Driving”, Tech. Rep., 2019, by Aptiv, Audi, Baidu, BMW, Continental, Daimler, FCA, here, Infineon, Intel, and Volkswagen, contents of ISO 21448:2022, and contents of IEEE 2846-2022 are incorporated by reference in their entirety.

### Description of Terms

The following describes terms related to the disclosure in the present disclosure. The present disclosure is included in the embodiments of the description.

A road user may be a traffic participant on or adjacent to an active road for the purpose of moving from a certain place to another place.

A dynamic driving task (DDT) may be a real-time operation functionality and a real-time strategic functionality for operating a vehicle in traffic. The dynamic driving task may be all real-time operation functionalities and real-time strategic functionalities for operating the vehicle on the road.

An automated driving system (ADS) may be a batch of hardware and software capable of continuously executing the entire DDT regardless of whether the automated driving system is limited to a specific operational design domain.

ADS functionality (ADS feature) may be a design-specific functionality of the ADS in a specific ODD at a predetermined automated driving level.

A DDT fallback may be a response by a driver or an automated system to either execute a DDT or transition to a minimal risk condition after a failure occurs or upon detection of a functional insufficiency or a potentially hazardous behavior. The DDT fallback may be a method of transition control from autonomy to control by a driver or other systems using takeover/fallback states and associated use cases. The DDT fallback may be a response by the user for executing the DDT or achieving an MRC after the occurrence of a system failure related to the DDT capability or during deviation from the ODD, or a response by the ADS for achieving the MRC when placed in the same situation.

The minimal risk condition (MRC) may be a vehicle state in order to reduce the risk, when a predetermined trip cannot be completed. The minimal risk condition may be a stable stop state that the user or the ADS brings to the vehicle after the DDT fallback is executed in order to reduce the risk of an accident when the predetermined trip cannot or should not be continued.

The operational design domain (ODD) may be a specific condition which is designed such that a predetermined (automated) driving system functions. The operational design domain is an operation condition specially designed such that a predetermined ADS or a functionality thereof functions, and includes, but is not limited to, the presence or absence of requirements of environmental, geography, and time zone restrictions, and/or certain traffic/road properties.

Safety of the intended functionality (SOTIF) may be the absence of unreasonable risks due to inadequacy of the intended functionality or the implementation functionality thereof.

A driving policy may be a strategy and a rule defining a control action at a vehicle level.

A situation is a factor that can affect a behavior of a system, and may include traffic situations, weather, and a behavior of an ego-vehicle.

A scenario may be a description of the temporal relationships between several scenes in a series of scenes, including goals and values in a specific situation influenced by actions and events. The scenario may be a description of consecutive activities in time series in which a vehicle as a main-object, all external environments thereof, and interactions thereof in a process of executing a specific driving task are integrated.

A safety-relevant object may be any moving or static object that may be relevant to the safety capability of the DDT.

The term “reasonably foreseeable” may mean being technically reliable and having a credible or measurable occurrence rate.

A triggering condition may be a specific condition of a scenario functioning as a trigger for a response that is a response of a subsequent system and that contributes to inability to prevent, detect, and reduce hazardous behaviors and reasonably foreseeable indirect misuse.

The minimal risk maneuver (MRM) may be a movement of the vehicle instructed by the automated driving system during the DDT fallback to achieve the MRC.

The risk acceptance criteria/criterion are/is criteria/a criterion indicating that there is no unreasonable level of risk, and may be, for example, a physical parameter defining when a specific behavior is regarded as an unsafe behavior, the maximum number of accidents per hour, the lowest level that is reasonably executable, or the like.

A proper response may be an action that is significant to avoid and ameliorate a hazardous situation in a reasonably foreseeable scenario in which other safety-relevant objects are operating within an assumption range.

The safety-related model may be representation of a safety-related aspect of the driving action based on assumptions on the reasonably foreseeable behavior of other road users. The safety-related model may be an on-board or off-board safety checker or an on-board or off-board safety analysis device, a mathematical model, a set of more conceptual rules, a set of scenario-based behavior, or a combination thereof.

A formal model may be a model represented in a formal representation used for system capability verification.

A safety envelope may be a set of restrictions and conditions that are designed for a (automated) driving system to operate as a target for a constraint or a control in order to maintain an operation at an acceptable risk level. The safety envelope may be a general concept that can be used to deal with all principles on which the driving policy can be based. According to this concept, an ego-vehicle operated by the (automated) driving system can have one or multiple boundaries around the ego-vehicle.

The verification may be an activity for determining that the operation of the vehicle equipped with the (autonomous) driving system achieves the safety of the (autonomous) driving system application defined in the intended environment.

The validation may be an activity for determining that an inspection object satisfies a designated requirement.

The positive risk balance may be a criterion to demonstrate that a technical solution achieves an acceptable level of residual risk.

The object and event detection and response (OEDR) may be a sub-task of the DDT including monitoring the driving environment and executing an appropriate response to such an object or event.

A response time may be a time required for the road user to sense a specific stimulus and start executing a response (braking, steering, acceleration, stopping, or the like) in a predetermined scenario.

### First Embodiment

### Driving System

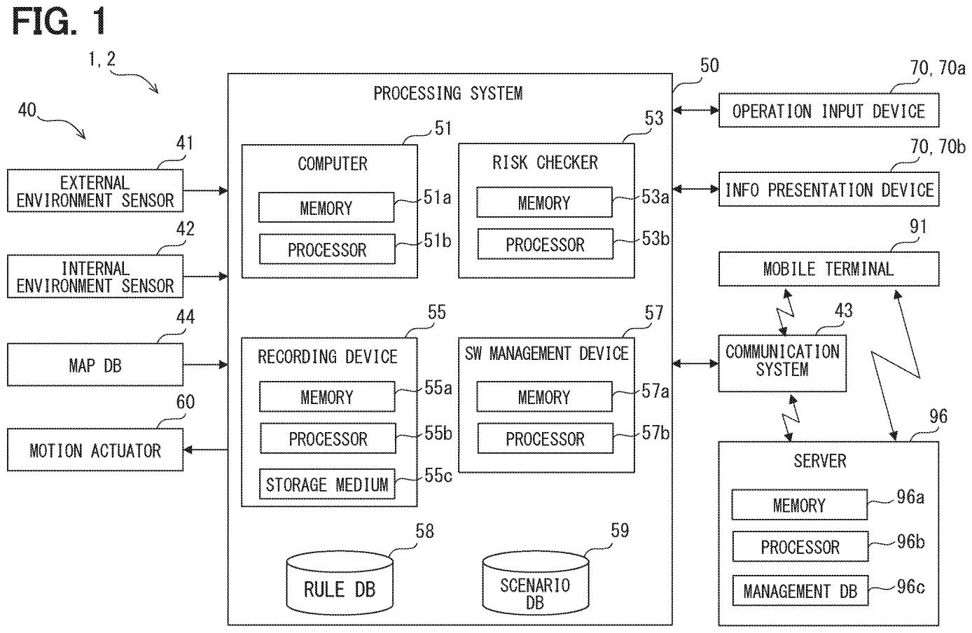

A driving system 2 of a first embodiment illustrated in FIG. 1 implements functionalities related to driving of a vehicle 1. The driving system 2 may be a vehicle system itself or may be a component forming a part of the vehicle system. A part or all of the driving system 2 is mounted on the vehicle 1. The vehicle 1 may be referred to as an ego-vehicle, a host vehicle, or the like. The vehicle 1 may be configured to communicate with another vehicle or the like directly or indirectly via communication infrastructure. The other vehicle is referred to as a target vehicle in some cases.

The vehicle 1 may be, for example, a road user capable of executing manual driving of a four-wheeled automobile or a truck. The vehicle 1 may further be capable of executing automated driving. The automated driving may be referred to as autonomous driving by the driving system 2. Levels of the driving are classified in accordance with a range or the like of tasks executed by a human driver, among all dynamic driving tasks (DDTs). The automation level is defined, for example, in SAE J3016. At levels 0 to 2, the driver performs a part or all of the DDT. Levels 0 to 2 may be classified as so-called manual driving. Level 0 indicates that driving is not automated. Level 1 indicates that the driving system 2 supports the driver. Level 2 indicates that driving is partially automated.

At level 3 or higher, the driving system 2 performs the entire DDT while the ADS functionality (ADS feature) is operating. Levels 3 to 5 may be classified as so-called automated driving. Systems capable of executing driving at level 3 or higher may be referred to as automated driving systems (ADS). A vehicle on which an automated driving system is mounted or a vehicle capable of executing driving at level 3 or higher may be referred to as an automated vehicle/autonomous vehicle (AV).

Level 3 indicates that driving is conditionally automated. The automated driving system at level 3 executes the DDT but does not execute the DDT fallback. That is, the DDT fallback is executed by a driver who is ready for fallback. Level 4 indicates that driving is highly automated. The automated driving system at level 4 executes the DDT and the DDT fallback. The automated driving system at level 4 can cause the driver to take over the DDT after reaching the minimal risk condition (MRC) by executing the DDT fallback or the like. Level 5 indicates that driving is fully automated. The takeover of the DDT between the driving system 2 and the human driver is also referred to as authority transfer.

The conditions for executing automated driving at levels 3 and 4 may include some or all of the conditions indicated by the operational design domain (ODD). For example, the ADS functionality may be defined within the range of ODD. The driving system 2 described in the present embodiment is a driving system capable of executing automated driving at level 3 or more.

The driving system 2 provides a functionality such as automated driving to a vehicle user of the vehicle 1 who can participate in open road traffic. For example, the vehicle user may be a driver in the vehicle 1. The vehicle user may be an occupant in the vehicle 1. For example, when the vehicle 1 is a personally owned vehicle (POV), the vehicle user may be an owner who owns the vehicle 1. For example, when the vehicle 1 is used for mobility as a service (MaaS), the vehicle user may be an operation administrator who manages the operation of the vehicle 1.

An architecture of the driving system 2 is selected such that safety of the intended functionality (SOTIF) process can be implemented. For example, the architecture of the driving system 2 may be configured based on a sense-plan-act model. The sense-plan-act model includes a sense element, a plan element, and an act element, as main system elements. The sense element, the plan element, and the act element interact with one another. The sense may be replaced with perception, the plan may be replaced with determination, and the act may be replaced with control, respectively.

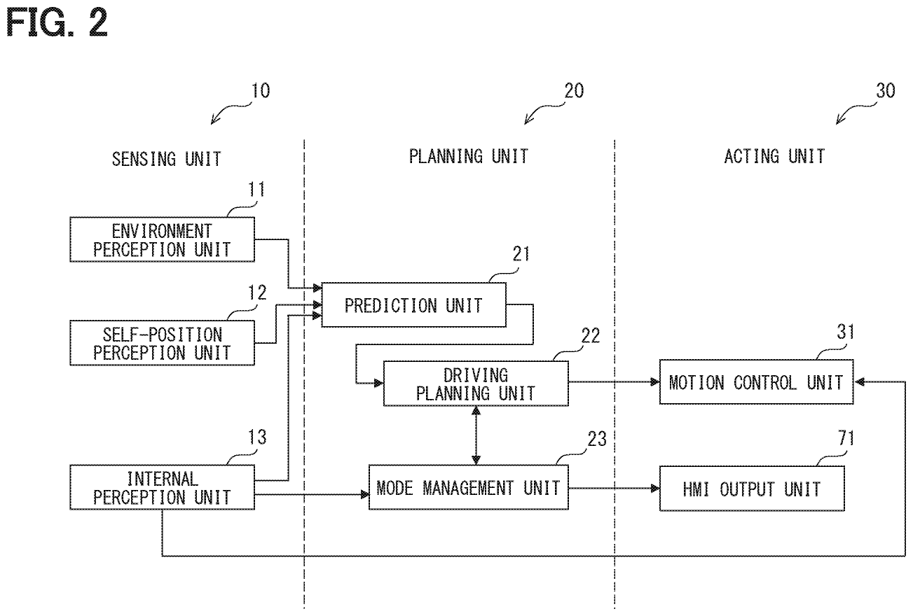

In such driving system 2, at a technical level (in other words, a technical perspective), at least multiple sensors 40 corresponding to the sensing functionality, at least one processing system 50 corresponding to the planning functionality, and multiple motion actuators 60 corresponding to the acting functionality are implemented. In the functionality level (in other words, a functional viewpoint), a sensing functionality, a planning functionality, and an acting functionality are implemented (also see FIG. 2).

Specifically, a sensing unit 10 as a processing unit for implementing the sensing functionality mainly using the multiple sensors 40, a processing system 50 that processes sense information of the multiple sensors 40, and a processing system 50 that generates an environment model based on information of the multiple sensors 40 may be constructed in the driving system 2. A planning unit 20 and a risk checking unit 26 as processing units for implementing the planning functionality mainly using the processing system 50 may be constructed in the driving system 2. An acting unit 30 as a processing unit for implementing the acting functionality mainly using multiple motion actuators 60 and at least one processing system 50 that outputs an operation signal of the multiple motion actuators 60 may be constructed in the driving system 2.

The sensing unit 10 may be implemented in a form of a sensing system serving as a subsystem that is provided to be distinguishable from the planning unit 20 and the acting unit 30. The planning unit 20 may be implemented in a form of a planning system as a subsystem that is provided to be distinguishable from the sensing unit 10 and the acting unit 30. The planning system may include the risk checking functionality. The risk checking functionality may be mounted on the driving system 2 independently of the sensing unit 10, the planning unit 20, and the acting unit 30. The acting unit 30 may be implemented in a form of an acting system serving as a subsystem that is provided to be distinguishable from the sensing unit 10 and the planning unit 20. The sensing system, the planning system, and the acting system may form independent components. The subsystem here may be replaced with a module, a unit, a device, or the like.

The sensing unit 10 serves as the sensing functionality including localization (for example, estimation of position) of a road user such as the vehicle 1 and another vehicle. The sensing unit 10 senses an external environment, an internal environment, and a vehicle state of the vehicle 1 and further, a state of the driving system 2. The sensing unit 10 fuses the sensed information to generate an environment model. The environment model may be referred to as a world model. The planning unit 20 applies a purpose and a driving policy to the environment model generated by the sensing unit 10 to derive a control action. The acting unit 30 executes the control action derived by the planning unit 20. (Physical Architecture)

An example of a physical architecture of the driving system 2 will be described by using FIG. 1. The driving system 2 includes the multiple sensors 40, the multiple motion actuators 60, multiple HMI devices 70, and at least one processing system 50. These elements can communicate with each other through one or both of a wireless connection and a wired connection. These elements may be capable of communicating with each other through, for example, an in-vehicle network such as a CAN (registered trademark).

The multiple sensors 40 include one or multiple external environment sensors 41. The multiple sensors 40 may include at least one type among one or multiple internal environment sensors 42, one or multiple communication systems 43, and a map database (DB) 44.

The external environment sensor 41 may detect a target object present in the external environment of the vehicle 1. Examples of the external environment sensor 41 of a target object detection type include a camera, a light detection and ranging/laser imaging detection and ranging (LiDAR), a laser radar, a millimeter wave radar, an ultrasonic sonar, and the like. Typically, a combination of multiple types of external environment sensors 41 may be mounted to monitor directions including a front direction, a side direction, and a rear direction of the vehicle 1.

The external environment sensor 41 may detect a state of an atmosphere or a state of weather in the external environment of the vehicle 1. The external environment sensor 41 of a state detection type is, for example, an outside air temperature sensor, a temperature sensor, or a raindrop sensor.

The internal environment sensor 42 may detect a specific physical quantity (hereafter, a motion physical quantity) related to a vehicle motion in the internal environment of the vehicle 1. Examples of the internal environment sensor 42 of a motion physical quantity detection type include a velocity sensor, an acceleration sensor, a gyro sensor, and the like. The internal environment sensor 42 may detect a state of an occupant in the internal environment of the vehicle 1. The internal environment sensor 42 of an occupant detection type is, for example, an actuator sensor, a sensor monitoring a vehicle user (for example, a driver) and a system thereof, a biometric sensor, a seating sensor, or an in-vehicle device sensor. In particular, examples of the actuator sensor include an accelerator sensor, a brake sensor, a steering sensor, and the like that detect an operation state of the occupant with respect to the motion actuator 60 related to motion control of the vehicle 1.

The communication system 43 acquires communication data usable in the driving system 2 through wireless communication. The communication system 43 may receive a positioning signal from an artificial satellite of a global navigation satellite system (GNSS) present in the external environment of the vehicle 1. A communication device of a positioning type in the communication system 43 is, for example, a GNSS receiver.

The communication system 43 may transmit and receive communication signals to and from an external system (for example, a server 96) present in the external environment of the vehicle 1. A communication device of a V2X type in the communication system 43 is, for example, a dedicated short range communications (DSRC) communication device, or a cellular V2X (C-V2X) communication device. Examples of the communication with a V2X system present in the external environment of the vehicle 1 include communication with a communication system of another vehicle (V2V), communication with infrastructure such as a communication device set in a traffic light or a roadside device (V2I), communication with a mobile terminal of a pedestrian (V2P), communication with a network such as a cloud server (V2N), and the like. An architecture of the V2X communication, including the V2I communication, may adopt an architecture defined in ISO 21217, ETSI TS 102 940-943, IEEE 1609, or the like.

The communication system 43 may transmit and receive a communication signal to and from the internal environment of the vehicle 1, for example, with a mobile terminal 91 such as a smartphone present in the vehicle. A communication device of a terminal communication type in the communication system 43 is, for example, a Bluetooth (registered trademark) device, a Wi-Fi (registered trademark) device, or an infrared communication device. When the mobile terminal 91 of the vehicle user is associated with the vehicle 1 in advance, the communication system 43 may transmit and receive a communication signal to and from the mobile terminal present in the external environment.

The map DB 44 is a database for storing map data usable in the driving system 2. The map DB 44 includes at least one type of non-transitory tangible storage medium of, for example, a semiconductor memory, a magnetic medium, or an optical medium. The map DB 44 may include a database of a navigation unit that navigates a travel route of the vehicle 1 to a destination. The map DB 44 may include a database of a probe data (PD) map generated by using PD collected from each vehicle. The map DB 44 may include a database of a high-definition map having a high level of definition mainly used for an automated driving system. The map DB 44 may include a database of a parking lot map including specific parking lot information, for example, parking space markings information, used for automated parking or parking support.

The map DB 44 appropriate to the driving system 2 acquires and stores the latest map data through, for example, communication with a map server via the communication system 43 of a V2X type. The map data is converted into two-dimensional or three-dimensional data as data indicating the external environment of the vehicle 1. The map data may include, for example, road data representing at least one type among positional coordinates, a shape, and a road surface condition of a road structure and a standard roadway. The map data may include marking data representing at least one type of, for example, a road sign, a road display, and a positional coordinate and a shape of a lane marking attached to a road. The marking data included in the map data may represent, for example, a traffic sign, an arrow marking, a lane marking, a stop line, a direction sign, a landmark beacon, a business sign, or a change in a line pattern of a road among target objects. The map data may include structure data representing at least one type of positional coordinates, a shape, and the like of a building and a traffic light facing the road, for example. The marking data included in the map data may represent, for example, a streetlight, a road edge, a reflecting plate, or a pole among the target objects.

The motion actuator 60 is capable of controlling a vehicle motion based on an input control signal. The motion actuator 60 of a driving type is a power train including, for example, at least one type among an internal combustion engine, a drive motor, and the like. The motion actuator 60 of a braking type is, for example, a brake actuator. The motion actuator 60 of a steering type is, for example, a steering.

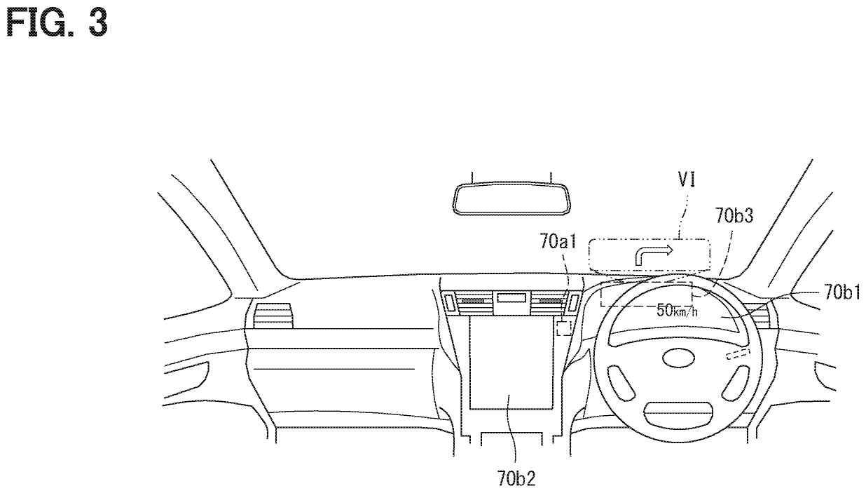

As illustrated in FIG. 3, multiple human machine interface (HMI) devices 70 may be mounted on the vehicle 1. The HMI device 70 implements a human machine interaction, which is an interaction between a user of the vehicle 1 and the driving system 2. Some of the multiple HMI devices 70, which implement an operation input functionality for the occupant, may be a part of the sensing unit 10. Some of the multiple HMI devices 70, which implement an information presentation functionality, may be a part of the acting unit 30. Meanwhile, the functionality implemented by the HMI device 70 may be provided as a functionality independent of the sensing functionality, the planning functionality, and the acting functionality.

The HMI device 70 may be an operation input device 70a capable of inputting an operation by the user to transmit the will or intention of the user of the vehicle 1 to the driving system 2. The HMI device 70 of an operation input type, that is, the operation input device 70a, is, for example, an accelerator pedal, a brake pedal, a shift lever, a steering wheel, a turn signal lever, a mechanical switch, and a touch panel of a navigation unit or the like. Among those, the accelerator pedal controls the power train serving as the motion actuator 60. The brake pedal controls the brake actuator serving as the motion actuator 60. The steering wheel controls a steering actuator serving as the motion actuator 60.

The HMI device 70 may be an information presentation device 70b that presents information such as visual information, auditory information, and cutaneous sensory information to the user of the vehicle 1. The HMI device 70 of the visual information presentation type, that is, the information presentation device 70b, is, for example, a meter display 70b1, a navigation unit, a center information display (CID) 70b2, a head-up display (HUD) 70b3, or an illumination unit.

The meter display 70b1 is, for example, a display device disposed in a driver facing portion of an instrument panel facing a driver's seat on which the driver sits. The meter display 70b1 displays information necessary for driving to the driver, focusing on the vehicle state including the velocity of the vehicle 1 and the like. The meter display 70b1 may be a graphic meter that displays all information by an image, or may be a combination meter that combines image display and analog display by a device.

The CID 70b2 is, for example, a display device disposed in a central portion of an instrument panel. The CID 70b2 has the largest display screen among in-vehicle display devices mounted on the instrument panel. The CID 70b2 can display an image not only to the driver but also to the passenger. The CID 70b2 may include a touch panel that can be touch-operated by the vehicle user, and in this case, the CID 70b2 also corresponds to the operation input device 70a.

The HUD 70b3 is a display device disposed on the instrument panel on a side opposite to the meter display 70b1 with the driver's seat being interposed therebetween, that is, on a back side of the driver facing portion. The HUD 70b3 projects an image onto a front windshield of the vehicle 1, thereby enabling the driver to display a virtual image VI that appears to be floating outside the vehicle.

Instead of the CID 70b2 and the meter display 70b1, a pillar-to-pillar display disposed to cross the left and right A-pillars may be adopted. Even in this case, the pillar-to-pillar display may be divided into several screens, each of which may be controlled in the same manner as the CID 70b2 and the meter display 70b1.

The HMI device 70 of an auditory information presentation type is, for example, a speaker and a buzzer. The HMI device 70 of a cutaneous sensory information presentation type is, for example, a vibration unit of the steering wheel, a vibration unit of a driver's seat, a reaction force unit of the steering wheel, a reaction force unit of the accelerator pedal, a reaction force unit of the brake pedal, and an air conditioning unit.

The HMI device 70 may implement an HMI functionality in cooperation with the mobile terminal 91 such as a smartphone by communicating with the terminal through the communication system 43. For example, as an alternative to the information presentation to the HMI device 70, the information of the driving system 2 may be displayed on the screen of the smartphone of the vehicle user through the communication system 43. On the other hand, the HMI device 70 may present information acquired from a smartphone to the user. For example, an operation input to the smartphone may be used as an alternative to an operation input to the HMI device 70.

The HMI device 70 may include, as the operation input device 70a, a feedback device 70a1 that receives feedback of the vehicle user. For example, the feedback device 70a1 includes a computer and a microphone, and when the feedback functionality is selected from the CID 70b2, the voice of the vehicle user is recorded using the microphone for a predetermined time (for example, 45 seconds). Accordingly, the vehicle user can feed back praise, dissatisfaction, or the like to the vehicle 1 or the driving system 2. The feedback device 70a1 may transmit, through the communication system 43, the recorded voice of the vehicle user to an external system present in the external environment. The external system may be the server 96 described below. The vehicle 1 or the driving system 2 can be improved by aggregating the feedback of the vehicle user in the external system.

At least one processing system 50 is provided. For example, the processing system 50 may be an integrative processing system that executes a process related to the sensing functionality, a process related to the planning functionality, and a process related to the acting functionality in an integrated manner. In this case, the integrative processing system 50 may further execute a process related to the HMI device 70, and an HMI dedicated processing system may be separately provided. For example, the HMI dedicated processing system may be an integrated cockpit system that integrally executes a process related to each HMI device 70. The processing system 50 may be provided by an in-vehicle platform that can be generally used for an AV.

For example, the processing system 50 may include each of at least one processing unit corresponding to the process related to the sensing functionality, at least one processing unit corresponding to the process related to the planning functionality, and at least one processing unit corresponding to the process related to the acting functionality.

The processing system 50 includes a communication interface for an outside, and is connected to at least one type of elements related to the process performed by the processing system 50 among each sensor 40, the motion actuator 60, the HMI device 70, and the like via at least one type among, for example, a local area network (LAN), a wire harness, an internal bus, and a wireless communication circuit.

The processing system 50 includes at least one dedicated computer 51. The processing system 50 may combine multiple dedicated computers 51 to implement a functionality such as the sensing functionality, the planning functionality, and the acting functionality.

For example, the dedicated computer 51 forming the processing system 50 may be an integrated ECU that integrates driving functionalities of the vehicle 1. The dedicated computer 51 forming the processing system 50 may be a determination ECU that determines a DDT. The dedicated computer 51 forming the processing system 50 may be a monitoring ECU that monitors driving of the vehicle 1. The dedicated computer 51 forming the processing system 50 may be an evaluation ECU that evaluates driving of the vehicle 1. The dedicated computer 51 forming the processing system 50 may be a navigation ECU that navigates a travel route of the vehicle 1.

The dedicated computer 51 forming the processing system 50 may be a locator ECU that estimates a position of the vehicle 1. The dedicated computer 51 forming the processing system 50 may be an image processing ECU that processes image data detected by the external environment sensor 41. The dedicated computer 51 forming the processing system 50 may be an actuator ECU that controls the motion actuator 60 of the vehicle 1. The dedicated computer 51 forming the processing system 50 may be an HMI control unit (HCU) that integrally controls the HMI devices 70. The dedicated computer 51 forming the processing system 50 may be, for example, at least one external computer that is provided in an external center or the mobile terminal 91 that enables communication via the communication system 43.

The dedicated computer 51 forming the processing system 50 includes at least one memory 51a and at least one processor 51b. The memory 51a may be, for example, at least one type of non-transitory tangible storage medium, such as a semiconductor memory, a magnetic medium, and an optical medium, which non-temporarily stores a computer program, data, and the like that can be read by the processor 51b. For example, a rewritable volatile storage medium such as a random access memory (RAM) may be provided as the memory 51a. The processor 51b includes, for example, at least one type of a central processing unit (CPU), a graphics processing unit (GPU), and a reduced instruction set computer (RISC)-CPU as a core.

The dedicated computer 51 forming the processing system 50 may be a system on a chip (SoC) in which the memory 51a, the processor 51b, and an interface are integrally implemented on one chip, or at least one SoC may be provided as an element of the dedicated computer 51.

The processing system 50 may include at least one database for executing the DDT. The database may include, for example, a non-transitory tangible storage medium of at least one type of a semiconductor memory, a magnetic medium, and an optical medium, and an interface for accessing the storage medium.

The database may be a scenario database (hereafter, referred to as “scenario DB”) 59. The database may be a rule database (hereafter, rule DB) 58. At least one of the scenario DB 59 and the rule DB 58 may not be provided in the processing system 50, but may be provided independently in the driving system 2. At least one of the scenario DB 59 and the rule DB 58 may be provided in an external system present in an external environment and configured to be accessible from the processing system 50 via the communication system 43.

The scenario DB 59 has a scenario catalog in which multiple scenarios used for driving the vehicle 1 are stored. The driving system 2 can, for example, apply the situation in which the vehicle 1 is located to one scenario selected from multiple scenarios or a combination of multiple scenarios. The scenario DB 59 may store multiple scenarios including at least one of a functional scenario, a logical scenario, and a concrete scenario. The functional scenario defines a top-level qualitative scenario structure. The logical scenario is a scenario obtained by assigning a quantitative parameter range to a structured functional scenario. The concrete scenario defines a boundary of a safety determination for distinguishing between a safe state and an unsafe state.

The rule DB 58 stores a rule set used for driving the vehicle 1. The rule set may include multiple rules. The rule set may further include a structure of the degree of priority for a series of rules, which is set based on a relative importance among the multiple rules. The rule set may be an implementation of guidelines for strategic driving of the vehicle 1.

The multiple rules may include rules based on laws, regulations, and a combination thereof. The multiple rules may include rules based on a preference that is not influenced by the laws, the regulations, or the like. The multiple rules may include rules based on a motion behavior based on an experience in the past. The multiple rules may include rules based on a characterization of a motion environment. The multiple rules may include rules based on ethical concerns. The multiple rules may include rules based on a basic principle of a safety model (for example, the five principles of an RSS model). The multiple rules may include a traffic rule. The traffic rule may be a rule defined in the Road Traffic Law, or may be a rule based on national or regional customs.

The rules such as the traffic rules stored in the rule DB 58 may be positioned as the information provided from the sensing unit 10 to the planning unit 20 by the sensing functionality, similarly to the map information acquired from the map DB 44.

The processing system 50 may also include at least one recording device 55 that records at least one of the sensing information, planning information, and action information of the driving system 2. The recording device 55 may include at least one large-capacity storage medium 55c. The storage medium 55c may be at least one type of non-transitory tangible storage medium among, for example, a semiconductor memory, a magnetic medium, and an optical medium.

The storage medium 55c may be implemented on a substrate in a form that is not easily detachable or replaceable, and in this form, for example, an embedded multi media card (eMMC) or the like using a flash memory may be adopted. At least one of the storage medium 55c may be in a form that is detachable and replaceable with respect to the recording device 55, and in this form, for example, an SD card or the like may be adopted.

The recording device 55 may have a functionality of selecting information to be recorded from among the sensing information, the planning information, and the action information. In this case, the recording device 55 may include a dedicated computer.

The dedicated computer provided in the recording device 55 has at least one memory 55a and at least one processor 55b. The memory 55a may be, for example, at least one type of non-transitory tangible storage medium, such as a semiconductor memory, a magnetic medium, and an optical medium, which non-temporarily stores a computer program, data, and the like that can be read by the processor 55b. For example, a rewritable volatile storage medium such as a random access memory (RAM) may be provided as the memory 55a. The processor 55b includes, for example, at least one type of a central processing unit (CPU), a graphics processing unit (GPU), and a reduced instruction set computer (RISC)-CPU as a core.

The dedicated computer may be a system on a chip (SoC) in which the memory 55a, the processor 55b, and an interface are integrally implemented on one chip, or at least one SoC may be provided as an element of the dedicated computer.

The recording device 55 may access the storage medium 55c, and execute recording in accordance with a data writing command from each unit of the driving system 2. The recording device 55 may determine information transmitted to the in-vehicle network, access the storage medium 55c, and execute recording based on determination of the processor 55b provided in the recording device 55.

The recording device 55 may not be provided in the processing system 50 but may be provided independently in the driving system 2. The recording device 55 may be provided in the external system present in the external environment, and configured to be accessible from the processing system 50 via the communication system 43.

The processing system 50 may include at least one risk checker 53. The risk checker 53 may be one aspect of on-board implementation of responsibility sensitive safety (RSS) as a safety model. The risk checker 53 may be an on-board checker for the planning functionality implemented by the dedicated computer 51. The risk checker 53 implements, by hardware independent of the planning unit 20, the risk checking unit 26 that implements the risk checking functionality.

The risk checker 53 may be configured mainly with a dedicated computer having at least one memory 53a and at least one processor 53b. The memory 55a may be, for example, at least one type of non-transitory tangible storage medium, such as a semiconductor memory, a magnetic medium, and an optical medium, which non-temporarily stores a computer program, data, and the like that can be read by the processor 55b. For example, a rewritable volatile storage medium such as a random access memory (RAM) may be provided as the memory 55a. The processor 55b includes, for example, at least one type of a central processing unit (CPU), a graphics processing unit (GPU), and a reduced instruction set computer (RISC)-CPU as a core.

The dedicated computer may be a system on a chip (SoC) in which the memory 53a, the processor 53b, and an interface are integrally implemented on one chip, or at least one SoC may be provided as an element of the dedicated computer.

As described above, the processing system 50 includes the memories 51a, 53a, and 55a that store software. The processors 51b, 53b, and 55b are configured to implement automated driving by operating software so that authority transfer can be performed between the system itself and the user. The software here may include the computer program itself used in the driving system 2. The software here may include an algorithm in the computer program used in the driving system 2. The software here may include parameters in the computer program used in the driving system 2. The software here may include AI or a trained model, which is implemented by, for example, a neural network used in the driving system 2. The software may include data stored in a database referred to in the processing system 50, data stored in the map DB 44, and the like. One piece of software may correspond to one application, may correspond to multiple applications, may be a part of one application, or may be software commonly used by multiple applications.

The processing system 50 may include at least one software management device 57. The software management device 57 implements a software management functionality. The software management device 57 may be referred to as a software management device.

The software management device 57 manages various types of software used in the processing system 50, such as the computer 51, the risk checker 53, the recording device 55, the rule DB 58, and the scenario DB 59. The software management device 57 may further manage software used in the driving system 2 outside the processing system 50. For example, the software management device 57 may manage data stored in the map DB 44, software used for a drawing process by the information presentation device 70b, software used for a communication process by the communication system 43, and the like.

The software management may include software version management, a download process and installation process, an uninstallation process, and the like. The software management may include a software test.

In order to implement a software management functionality, the software management device 57 may be mainly configured with a dedicated computer having at least one memory 57a and at least one processor 57b. The memory 57a may be, for example, at least one type of non-transitory tangible storage medium, such as a semiconductor memory, a magnetic medium, and an optical medium, which non-temporarily stores a computer program, data, and the like that can be read by the processor 57b. For example, a rewritable volatile storage medium such as a random access memory (RAM) may be provided as the memory 57a. The processor 57b includes, for example, at least one type of a central processing unit (CPU), a graphics processing unit (GPU), and a reduced instruction set computer (RISC)-CPU as a core.

The dedicated computer may be a system on a chip (SoC) in which the memory 57a, the processor 57b, and an interface are integrally implemented on one chip, or at least one SoC may be provided as an element of the dedicated computer.

The above-described architecture is merely an example, and various configurations can be adopted as the hardware configuration of the driving system 2.

### Logical Architecture in Automated Driving

Next, an example of a logical architecture of the driving system 2 will be described with reference to FIG. 2. The description here will focus on a process performed by a computer program executed during automated driving at the level 3 or higher. The sensing unit 10 may include an environment perception unit 11, a self-position perception unit 12, and an internal perception unit 13 as processing units for implementing, by executing a computer program by the processor 51b, sub-functionalities obtained by further classifying the sensing functionalities.

The environment perception unit 11 individually processes information (referred to as sensor data in some cases) on an external environment acquired from each sensor 40 and implements a functionality of perceiving the external environment including a target object, other road users, and the like. The environment perception unit 11 processes detection data detected by each external environment sensor 41 individually. The detection data may be detection data provided from, for example, a millimeter wave radar, a sonar, or a LiDAR. The environment perception unit 11 may generate relative position data including a direction, a size, and a distance of an object with respect to the vehicle 1, from raw data detected by the external environment sensor 41.

The detection data may be image data provided from, for example, a camera or a LiDAR. The environment perception unit 11 processes the image data, and extracts an object that is reflected in an angle of view of the image. The extraction of the object may include estimation of the direction, the size, and the distance of the object with respect to the vehicle 1. The extraction of the object may include, for example, classification of the object by using semantic segmentation.

The environment perception unit 11 processes information acquired through a V2X functionality of the communication system 43. The environment perception unit 11 processes information acquired from the map DB 44.

The environment perception unit 11 may be further classified into multiple sensor perception units each optimized for one sensor group. The sensor perception unit may fuse information of one sensor group when the sensor perception unit is associated to perceive information of the one sensor group.

The self-position perception unit 12 conducts localization of the vehicle 1. The self-position perception unit 12 acquires global position data of the vehicle 1 from the communication system 43 (for example, a GNSS receiver). In addition, the self-position perception unit 12 may acquire position information on the target object extracted by the environment perception unit 11. The self-position perception unit 12 acquires map information from the map DB 44. The self-position perception unit 12 integrates these pieces of information to estimate a position of the vehicle 1 on a map.

The internal perception unit 13 implements a functionality of perceiving a vehicle state by processing detection data detected by each internal environment sensor 42. The vehicle state may include a state of a motion physical quantity of the vehicle 1 detected by a velocity sensor, an acceleration sensor, a gyro sensor, or the like. The vehicle state may include at least one type of a state of a user, an operation state of the user with respect to the motion actuator 60, and a switching state of the HMI devices 70.

The planning unit 20 may include a prediction unit 21, a driving planning unit 22, and a mode management unit 23 as processing units for implementing, by executing a computer program by the processors 51b and 53b, sub-functionalities obtained by further classifying the planning functionalities.

The prediction unit 21 acquires external environment information perceived by the environment perception unit 11 and the self-position perception unit 12, the vehicle state perceived by the internal perception unit 13, and the like. The prediction unit 21 may interpret an environment based on the acquired information, and estimate the current situation in which the vehicle 1 is located. The situation here may be an operational situation, or may include an operational situation.

The prediction unit 21 may interpret the environment and predict actions of objects such as other road users. The object here may be a safety-relevant object. The prediction of the action here may include at least one of prediction of a velocity of the object, prediction of an acceleration of the object, and prediction of a trajectory of the object. The prediction of the act may be executed based on a reasonably foreseeable assumption. The prediction unit 21 may estimate an intention of the user, based on the predicted action, the predicted potential hazard, and the acquired vehicle state.

The driving planning unit 22 plans automated driving of the vehicle 1, based on at least one type of estimation information of the position of the vehicle 1 on the map provided by the self-position perception unit 12, prediction information and user intention estimation information provided by the prediction unit 21, functional constraint information provided by the mode management unit 23, and the like.

The driving planning unit 22 implements a route planning functionality, a behavior planning functionality, and a trajectory planning functionality. The route planning functionality is a functionality of planning at least one of a route to a destination and a lane plan at a middle distance based on the estimation information of the position of the vehicle 1 on the map. The route planning functionality may further include a functionality of determining at least one request of a lane changing request and a deceleration request, based on the lane plan at the middle distance. The route planning functionality may be a mission/route planning functionality in a strategic function, or may be a functionality of outputting a mission plan and a route plan.

The behavior planning functionality is a functionality of planning a behavior of the vehicle 1, based on at least one of the route to the destination and the lane plan at the middle distance planned by the route planning functionality, the lane changing request and the deceleration request, the prediction information and the user intention estimation information provided by the prediction unit 21, and the functional constraint information provided by the mode management unit 23. The behavior planning functionality may include a functionality of generating a condition related to a state transition of the vehicle 1. The condition related to the state transition of the vehicle 1 may correspond to a triggering condition. The condition related to the state transition may include a fallback condition for executing the DDT fallback.

The behavior planning functionality may include a functionality of determining a state transition of an application that implements a DDT, and further include a functionality of determining a state transition of a driving action, based on the condition. Accordingly, when the driving planning unit 22 plans the execution of the DDT fallback, and this does not involve authority transfer, the driving planning unit 22 may further execute a minimal risk maneuver (MRM) together with a motion control unit 31 to shift the vehicle 1 to the minimal risk condition. The planning of the MRM may be implemented by a behavior planning functionality or may be implemented by a trajectory planning functionality.

The behavior planning functionality may include a functionality of determining a constraint related to a path of the vehicle 1 in a longitudinal direction and a constraint related to the path of the vehicle 1 in a lateral direction, based on information on these state transitions. The behavior planning functionality may be strategic behavior planning in a DDT functionality, or may output a strategic behavior.

The trajectory planning functionality is a functionality of planning a travel trajectory of the vehicle 1, based on the determination information provided by the prediction unit 21, the constraint related to the path of the vehicle 1 in the longitudinal direction, and the constraint related to the path of the vehicle 1 in the lateral direction. The trajectory planning functionality may include a functionality of generating a path plan. The path plan may include a velocity plan, or the velocity plan may be generated as a plan independent of the path plan. The trajectory planning functionality may include a functionality of generating multiple path plans and selecting an optimal path plan from the multiple path plans, or a functionality of switching between the path plans. The trajectory planning functionality may further include a functionality of generating backup data of the generated path plan. The trajectory planning functionality may be a trajectory planning functionality in the DDT functionality, or may output a trajectory plan.

The mode management unit 23 monitors the driving system 2, and sets a constraint on a functionality related to driving. The mode management unit 23 may manage a mode of automated driving, for example, a state of the automation level. The management of the automation level may include switching between manual driving and automated driving, that is, authority transfer between the user and the driving system 2, that is, management of takeover of driving. The mode management unit 23 may monitor a state of a subsystem related to the driving system 2, and determine a defect of the system (for example, an error, an unstable operation state, a system failure, or a failure). The mode management unit 23 may determine a mode based on the intention of the user, based on the user intention estimation information generated by the internal perception unit 13. The mode management unit 23 may set a constraint on a functionality related to driving, based on at least one of a determination result of the defect of the system, a determination result of the mode, and further, the vehicle state provided by the internal perception unit 13, a sensor abnormality (or sensor failure) signal output from the sensor 40, state transition information of the application and the trajectory plan provided by the driving planning unit 22, and the like.

The mode management unit 23 may have a functionality of determining the constraint related to the path of the vehicle 1 in the longitudinal direction and the constraint related to the path of the vehicle 1 in the lateral direction in an integrated manner, in addition to the functional constraint related to driving. In this case, the driving planning unit 22 plans a behavior and plans a trajectory, in accordance with the constraint determined by the mode management unit 23.

When the risk checking functionality is implemented as a part of the planning unit 20, the risk checking functionality may be implemented as a part of the functionalities implemented by the prediction unit 21, the driving planning unit 22, and the mode management unit 23.

The risk checking functionality is a functionality of acquiring an environment model, sensor data, and the like from the sensing unit 10, evaluating a risk according to these pieces of information, and outputting a response according to the risk to the acting unit 30 or the driving planning unit 22. This series of functionalities or processes may be referred to as risk checking or risk monitoring.

More specifically, with the risk checking functionality, the situation is output based on the information acquired from the sensing unit 10. With the risk checking functionality, whether this situation is a safe situation or a hazardous situation is checked. The checking may include checking of an estimated result of a collision risk between the vehicle 1 and the surrounding object. In this checking, an index such as a collision probability can be used in consideration of uncertainty. The risk checking functionality may determine whether there is a hazardous situation by comparing an acceptable threshold of the collision risk with the estimated value of the collision risk. The threshold of the acceptable threshold of the collision risk may be set in advance based on risk acceptance criteria/criterion described in detail below.

The risk checking functionality derives a proper response based on the checking result. The proper response may be provided to the acting unit 30 or the driving planning unit 22 only when the situation is determined to be a hazardous situation. The proper response may be a restriction of a control command of the motion actuator 60. The proper response may be a response to return the vehicle 1 to a safe state.

The risk checking functionality is implemented by implementing a safety model. The safety model may be referred to as a safety-related model. The safety model may be a formal model. As the safety model, for example, the RSS model may be adopted. Meanwhile, another model such as an SFF model, a more generalized model, or a composite model obtained by combining multiple models may also be adopted. The SFF is a safety force field. The safety model monitors the risk of the vehicle 1 based on the driving policy. In other words, it can be said that the monitoring of the risk is monitoring of the driving policy.

In the RSS model, for example, a safe distance in a longitudinal direction and a safe distance in a lateral direction with respect to other road users are used as indexes used for checking the collision risk. The safe distance is an example of a geometric approach such as a safety envelope.

The acting unit 30 may include the motion control unit 31 and an HMI output unit 71 as processing units for implementing, by executing a computer program by the processor 51b, sub-functionalities obtained by further classifying the action functionalities. The motion control unit 31 controls a motion of the vehicle 1, based on the trajectory plan (for example, the path plan and the velocity plan) acquired from the driving planning unit 22. Specifically, the motion control unit 31 generates accelerator request information, shift request information, brake request information, and steering request information corresponding to the trajectory plan, and outputs the accelerator request information, the shift request information, the brake request information, and the steering request information to the motion actuator 60.

The motion control unit 31 is capable of directly acquiring the vehicle state perceived by the sensing unit 10 (particularly, the internal perception unit 13), for example, at least one of a current velocity, a current acceleration, and a current yaw rate of the vehicle 1 from the sensing unit 10, and reflecting the vehicle state on the motion control of the vehicle 1.

The HMI output unit 71 outputs information on an HMI, based on at least one of the prediction information and the user intention estimation information provided by the prediction unit 21, the state transition information of the application and the trajectory plan provided by the driving planning unit 22, the functional constraint information provided by the mode management unit 23, and the like. The HMI output unit 71 may manage a vehicle interaction. The HMI output unit 71 may generate a notification request based on a management state of the vehicle interaction, and control an information presentation functionality of the HMI devices 70. The HMI output unit 71 may generate a control request for a wiper, a sensor cleaning device, a headlight, and an air conditioner based on the management state of the vehicle interaction, and control these devices.

### Test in Open Road Traffic

It is required to execute a verification and validation (V&V) process on the driving system 2 described above. The V&V here may be V&V for a functionality intended by the software used in the driving system 2 or V&V for SOTIF. A scenario that the vehicle 1 may encounter can be classified into a known hazardous scenario, a known non-hazardous scenario, an unknown hazardous scenario, and an unknown non-hazardous scenario. The V&V process may be a process that reduces risks of a known hazardous scenario and an unknown hazardous scenario among these scenarios.

In the V&V of the driving system 2, there are verification for satisfying a safety requirement of each technical level and verification for safe integration of elements. The verification for satisfying the safety requirement of each technical level may include evaluation of at least one of the following functionalities and capabilities, preferably all of the functionalities and capabilities. The verification may include evaluation of other functionalities and capabilities.

For example, an evaluation target for the sensing unit 10 is a functionality of the sensor 40 or an external data source (for example, a map data source), a functionality of a sensor algorithm that models an environment, and dependability of the infrastructure and the communication system 43.

For example, the evaluation target related to the planning unit 20 is the ability of the determination algorithm. The ability of the determination algorithm is, for example, an ability of safely handling a potential lack of functionality, and an ability of making a proper determination according to an environment model, a driving policy, a current destination, and the like. For example, the evaluation targets related to the planning unit 20 include one of the absence of unreasonable risks due to hazardous behaviors of the intended functionality, the functionality of the system to safely handle ODD use cases, a robust capability of execution of the entire ODD driving policy, suitability for DDT fallback, and suitability for minimal risk conditions.

For example, the evaluation target may include not only the nominal capability of the system or the functionality but also the robust capability. The robust capability of the system or the functionality is a robust capability of a system under adverse environmental conditions affected by various disturbances, suitability of a system operation under known triggering conditions, sensitivity of an intended functionality, an ability to monitor various scenarios, or the like.

The V&V may be executed with a goal of achieving a positive risk balance by the automated driving executed by the driving system 2. It can be said that the positive risk balance is a main measure of a logically acceptable risk level.

More specifically, the V&V may be executed with a goal of achieving risk acceptance criteria/criterion that can be set based on the positive risk balance. The quantitative criterion of the risk acceptance criteria/criterion is, for example, a probability of occurrence of harm falling below a threshold. The risk acceptance criteria/criterion may be set by, for example, a combination of a statistical approach such as traffic accidents and an approach based on a scenario.

When software related to at least one of behavior planning and trajectory planning by the driving planning unit 22 is verified or tested, it is necessary to confirm that the driving system 2 performs at least a safer behavior than a competent and careful driver or an experienced and attentive driver. When software is tested in a virtual environment, for example, a verification method based on a software-in-the-loop (SiL) may be conducted using a reference data set including a scenario stored in a scenario DB.

When software related to mode management by the mode management unit 23 is verified or tested, in particular, the verification or test related to the determination of the ODD and the management of an operating state and a non-operating state may be conducted by SiL, may be conducted by a hardware-in-the-loop (HiL), or may be conducted by both.

When the software related to the HMI by the HMI output unit 71 or the like is verified or tested, the verification or test may be conducted by the HiL and a driver-in-the-loop (DiL). The test with the DiL may be performed on a vehicle user who does not have previous experience or knowledge about the driving system 2 and is unfamiliar with automated driving.

As described above, in the verification or test of the software in the driving system 2, a verification method such as the SiL, the HiL, and the DiL may be selected according to the target and purpose of the verification or test. The loop used for the SiL, the HiL, and the DiL may be an opened loop or a closed loop.

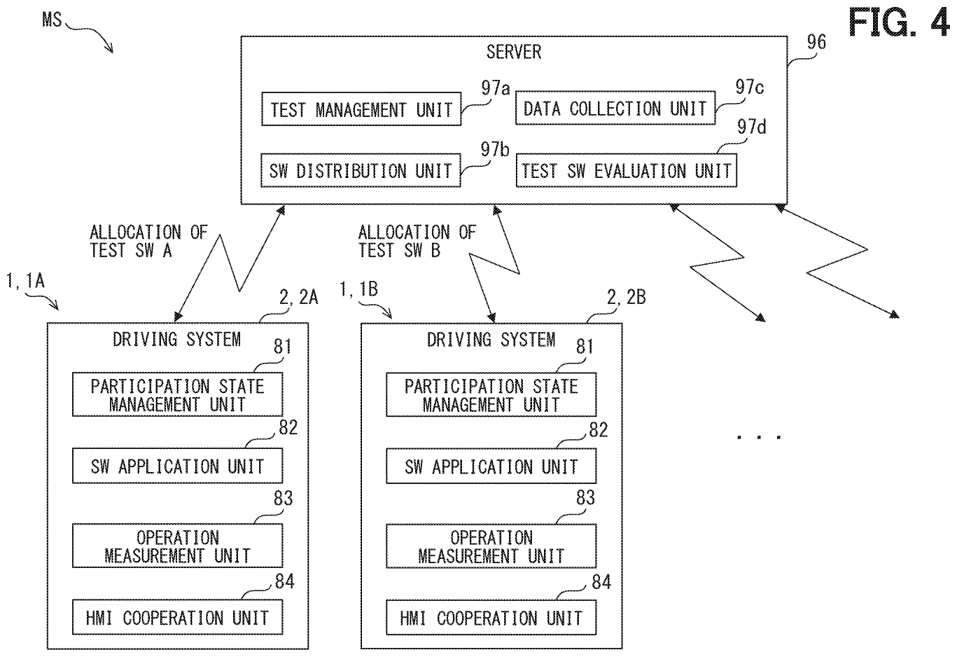

In order to manage an unacceptable risk and improve the driving system 2, it is preferable that there is a strong management system MS for the driving system 2 of the vehicle 1 that participates in open road traffic after being shipped to the market. For example, a management system MS illustrated in FIG. 4 executes changing of the software for a vehicle population by over-the-air (OTA). The management system MS includes the vehicle population including multiple vehicles 1A, 1B, . . . , and the server 96. The vehicles 1A and 1B managed by the management system MS may have the same configuration as the vehicle 1 including the driving system 2 described above, and some of the hardware specifications such as the vehicle type and the vehicle model may be different from each other as long as there is compatibility in the software specifications at least.

In the test in the changing process, data collected while each of the vehicles 1A and 1B belonging to the vehicle population is traveling on an open road may be used. In the test in the changing process, an index related to safety may be used. The result of the validation using the index related to safety may not be used only to determine whether the test software is applicable. For example, the result may be used to set the ODD itself or to set parameter restrictions by the ODD. The setting here may include a specification change by software update.

In the following description, software used for a temporary test may be referred to as test software, and software used formally (permanently) may be referred to as formal software.

The test by the management system MS is not limited to software update, and may be conducted to improve the environment in which the driving system 2 is used. That is, the result of the test may be fed back to city planning. For example, as a result of the test, a road shape such as an intersection or a merging point may be changed to a shape with higher safety. For example, as a result of the test, the control of the traffic signal at an intersection or the like may be changed to the control in which an occurrence frequency of traffic congestion decreases. In this case, the test may not involve application of the test software.

The index related to safety may be a value obtained by indexing the risk checked by the risk checking unit 26. The value obtained by indexing the risk includes, for example, the risk value, the safety envelope, the safety distance, and the violation metric (violation degree) described above. The violation metric (violation degree) is a value obtained by evaluating the degree of violation of the vehicle 1 (test target vehicle) with respect to the rule stored in the rule set.

The index related to safety may be a safety metric of the automated driving system. The safety metric may mean a scale that can be quantified based on collision rates. Examples of the safety metric include the severity and frequency of collision, the severity and frequency of citable offences, the distances in the longitudinal direction and the lateral direction, the accelerations in the longitudinal direction and the lateral direction, the jerk in the longitudinal direction and the lateral direction, the OEDR response time, and the like. The severity of the collision may be evaluated in six stages using, for example, an abbreviated injury scale (AIS). The distances in the longitudinal direction and the lateral direction are indexes related to maintenance of a safety envelope or a safety distance.

The evaluation of an index or the like related to safety may be a human evaluation. The human here may be a vehicle user of a test target vehicle. The human here may be a vehicle user unfamiliar with automated driving. In the test with the DiL, the evaluation index may be an evaluation input by a driver who is a vehicle user through the operation input device 70a (for example, the feedback device 70a1) of the test target vehicle, or may be an evaluation input through the mobile terminal 91 owned by the driver. The human here may be another VRU such as a pedestrian who encounters the test target vehicle. In this case, the evaluation may be an evaluation transmitted to the driving systems 2A and 2B of the vehicles 1A and 1B or the server 96 by another VRU who feels that the test target vehicle is hazardous using the mobile terminal 91 or the like owned by the VRU.

The management system MS may execute, using the vehicle population, a test of software that can be used in the driving systems 2A and 2B. The management system MS may apply the software whose validity is checked by the test to each of the driving systems 2A and 2B in the vehicle population. As described above, the management system MS functions as a test system that tests the validity of the driving systems 2A and 2B and the environment in which the driving systems 2A and 2B are used.

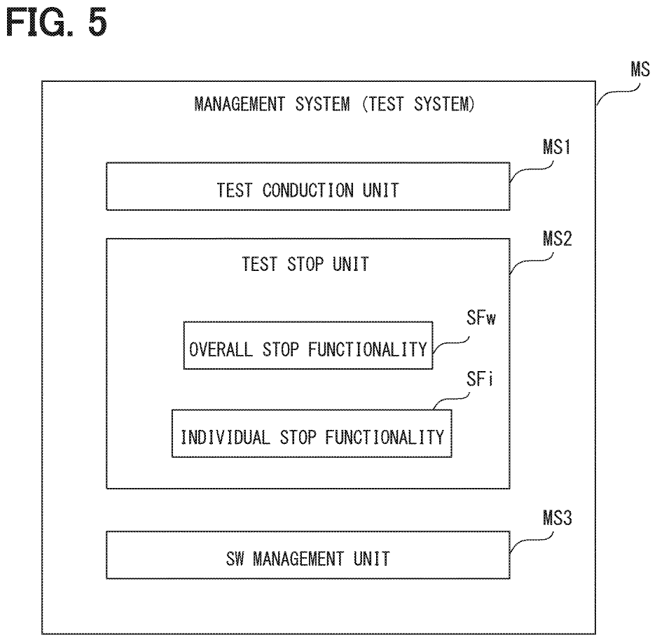

As illustrated in FIG. 5, the management system MS may construct a test conduction unit MS1, a test stop unit MS2, and a software management unit MS3 as processing units, for example, processors implemented by cooperation between the server 96 and the driving systems 2A and 2B.

The test conduction unit MS1 sets a test plan by the server 96, and conducts a test using the driving systems 2A and 2B of some or all of the vehicles 1A and 1B in the vehicle population. A process related to the overall test planning may be conducted mainly by a test management unit 97a of the server 96. A process related to the conduction of a test may be executed mainly by the test management unit 97a, a software distribution unit 97b, a data collection unit 97c, and a test software evaluation unit 97d of the server 96, and a participation state management unit 81, a software application unit 82, and an operation measurement unit 83 of the driving systems 2A and 2B.

The test stop unit MS2 has both an individual stop functionality SFi for individually stopping the test in a participation unit and an overall stop functionality SFw for stopping the test as a whole in a test standby-ready state or a test conduction state, and executes processes related to the individual stop functionality SFi and the overall stop functionality SFw. The unit of participation in the test may be, for example, one vehicle unit. The term “stop” here means a stop of a test conduction state, and means a concept including a temporary stop and a permanent stop. The temporary stop may be referred to as an interruption, and the permanent stop may be referred to as cancellation. The process related to the individual stop functionality SFi may be executed mainly by, for example, the participation state management unit 81 of the driving systems 2A and 2B, and may be executed mainly by the test management unit 97a of the server 96. The process related to the overall stop functionality SFw may be executed mainly by, for example, the test management unit 97a of the server 96.

The software management unit MS3 distributes test software to a test target vehicle along with the test, and manages an operation of the software. The software management unit MS3 executes rewriting of software, switching of software, and the like based on the enabled states of the individual stop functionality SFi and the overall stop functionality SFw. The process related to software management may be executed mainly by, for example, the software distribution unit 97b of the server 96 and the software application unit 82 of the driving systems 2A and 2B.

### Configuration Example of Server in Management System

As illustrated in FIGS. 1 and 4, the server 96 is placed in an external environment with respect to the vehicles 1A and 1B. The server 96 is communicably connected to the vehicles 1A and 1B by, for example, V2X communication via a communication infrastructure. The server 96 may be connected to, for example, an operation terminal operated by a human operator, and may form a remote management center that manages the vehicle population together with the operation terminal.

As illustrated in FIG. 1, the server 96 may be mainly implemented by a dedicated computer including at least one memory 96a and at least one processor 96b. The memory 96a may be, for example, at least one type of non-transitory tangible storage medium, such as a semiconductor memory, a magnetic medium, and an optical medium, which non-temporarily stores a computer program, data, and the like that can be read by the processor 96b. For example, a rewritable volatile storage medium such as a random access memory (RAM) may be provided as the memory 96a. The processor 96b includes, for example, at least one type of a central processing unit (CPU), a graphics processing unit (GPU), and a reduced instruction set computer (RISC)-CPU as a core.

The dedicated computer may be a system on a chip (SoC) in which the memory 96a, the processor 96b, and an interface are integrally implemented on one chip, or at least one SoC may be provided as an element of the dedicated computer.

The server 96 may further include a management database (hereafter, the management DB) 96c. The management DB 96c may store information for specifying the vehicles 1A and 1B to be managed by the management system MS. The management DB 96c may store information on specifications of the vehicles 1A and 1B. The management DB 96c may store various types of information collected from the vehicles 1A and 1B. The various types of information may include information for executing an evaluation in a test to be described below. The various types of information may include a status indicating whether the vehicle participating in the test is conducting the test or is in a stopped state.

The server 96 implements a software improvement functionality based on the V&V process preferable for the driving system. As illustrated in FIG. 4, the server 96 may include the test management unit 97a, the software distribution unit 97b, the data collection unit 97c, and the test software evaluation unit 97d as processing units for implementing the functionality by the processor 96b executing a computer program.

The test management unit 97a manages a test using the vehicle population. One type of test software may be prepared as an improved version of software (hereafter, referred to as conventional software) being applied to the vehicle population, and the test may be conducted. When two types of test software are prepared and the two types of test software are compared with each other, this test is referred to as an AB test. The multiple pieces of test software may be three or more types of software that have similar functionalities and can be compared with one another.

In the following, as a typical example of the AB test, an example in which one of multiple pieces of test software is allocated to one test target vehicle will be mainly described. On the other hand, various methods can be adopted as a test method, and for example, the AB test can be conducted by allocating multiple pieces of test software to one test target vehicle.

The test software is provided by, for example, a human administrator (hereafter, a test administrator) of the server 96. In this case, the test is conducted for the purpose of selecting the optimum software from the software as a release candidate. On the other hand, when the test is conducted to optimize the parameters used for the computer program, the test software may be software automatically generated by the test management unit 97a. For example, the test software may be automatically generated by changing parameters such as a determination threshold, an upper limit, and a lower limit of an existing program.

The test management unit 97a manages the scale of the test and the period of the test. The scale and the period may be set to values input to the server 96 by the test administrator, or may be automatically set by the test management unit 97a. The test management unit 97a determines, based on the scale and the period, a test target vehicle suitable for conducting the test from the vehicles 1A and 1B belonging to the vehicle population. When the number of vehicles incorporated in the management system MS is smaller than the optimum scale for conducting the test, all the vehicles 1A and 1B belonging to the vehicle population may be designated as the test target vehicles.

The test management unit 97a allocates one of the multiple pieces of test software to the test target vehicle in the vehicles 1A and 1B belonging to the vehicle population. In the AB test for comparing test software A and test software B, for example, half of the test target vehicles test the test software A, and the remaining half of the vehicles test the test software B. The test management unit 97a may randomly allocate the test software to the vehicles 1A and 1B using a pseudo-random number. The test management unit 97a may refer to vehicle information stored in the management DB 96c and execute the allocation of the test software so as to reduce the bias of the condition between the groups for testing the test software.

The test management unit 97a may restrict the test conduction content. For example, the test management unit 97a may limit the test conduction area to a specific country or region. The test management unit 97a may restrict a time zone in which the test is conducted to, for example, only a daytime time zone.

The test management unit 97a sets at least one evaluation index for evaluating the test software. The evaluation index may be set, based on the functionalities and properties of the test software or the intention of the test, to an index determined by the input operation of the test administrator to the server 96. Alternatively, the evaluation index may be set by the test management unit 97a based on the functionalities and properties of the test software. The evaluation index may include an index related to safety.

The test management unit 97a may manage at least one of a method of acquiring consent of the vehicle user for applying the test software in each test target vehicle and consent content. The test management unit 97a may leave the management of at least one of the consent acquisition method and the consent content entirely to the driving systems 2A and 2B of each test target vehicle.

The consent content may include information on whether to permit the test exit of a participation unit (that is, a cancellation policy) during the conduction of the test. For example, when the test content or the evaluation index thereof requires continuity of conduction of the test, the consent content may include prohibiting the exit of the test caused by the vehicle user for the entire period of the test or a certain period in the test period. The test requiring continuity of the conduction of the test refers to, for example, a test for verifying a period until the driver gets used to a new user interface, or a test for verifying a period until the occupant gets used to new vehicle control.

When the vehicle user can select the presence or absence of prohibition of test exit caused by the vehicle user over a period of time, an incentive may be provided to the vehicle user who has agreed with the consent content including the prohibition of exit. The provision of the incentive may be, for example, a functionality upgrade of the vehicle 1, issuance of a discount coupon for an optional functionality of the vehicle 1, or granting of electronic money or points. The functionality upgrade of the vehicle 1 may be, for example, cancelling a seat heater functionality, which is equipped in the vehicle 1 but is locked, during the test conduction period. Then, at the end of the test, the vehicle user can purchase the seat heater functionality at a discount price using the discount coupon and permanently use the seat heater functionality.

The test management unit 97a determines whether to start the test as a whole in the test standby-ready state. It can be said that the suspension of the start of the test as a whole is enabling of the overall stop functionality SFw. The test management unit 97a determines whether to stop the test as a whole in the test conduction state. The stopping of the test as a whole can be said to be enabling the overall stop functionality SFw. When the overall stop functionality SFw is enabled, the test management unit 97a may determine whether it is a permanent stop or a temporary stop. When the overall stop functionality SFw is enabled and the enabled stop is a temporary stop, the test management unit 97a may disable the overall stop functionality SFw and determine whether to resume the conduction of the test.

The test management unit 97a may manage the individual stop functionality SFi in addition to the management of the overall stop functionality SFw. The test management unit 97a may acquire information on enabling and disabling of the individual stop functionality SFi from the driving systems 2A and 2B of each test target vehicle and aggregate the information. The test management unit 97a may determine whether to individually stop the test of each test target vehicle and request the driving systems 2A and 2B to perform control based on the determination.

The software distribution unit 97b distributes the test software to the driving system 2 of the test target vehicle based on the allocation of the test software set by the test management unit 97a. Information on the planning of the test may be distributed together with the distribution of the test software. The information on the planning of the test includes information on a period and an evaluation index of the test, and may further include information such as a scale of the test. Accordingly, the test software distributed by each of the driving systems 2A and 2B is temporarily applied, and the test is started.

The data collection unit 97c collects information on an operation of the test software or an operation result thereof as probe data from each of the driving systems 2A and 2B to which the test software is temporarily applied. The information to be collected may include at least one of an index itself related to safety and information for deriving the index related to safety. The data collection unit 97c accumulates the data sequentially collected from the vehicles 1A and 1B in the management DB 96c.

The test software evaluation unit 97d compares multiple pieces of test software. The test software evaluation unit 97d compares the evaluation indexes, which are set by the test management unit 97a, between pieces of test software. When there are multiple evaluation indexes, the test software evaluation unit 97d compares each of evaluation indexes between pieces of test software.

Specifically, the test software evaluation unit 97d statistically processes the data from the vehicles 1A and 1B accumulated in the management DB 96c. For example, when the evaluation index can be expressed by a ratio such as an occurrence rate, the test software evaluation unit 97d calculates an occurrence rate per vehicle and/or per unit time from the occurrence frequency in the data from the vehicles 1A and 1B.

In the evaluation using the safety metric as the evaluation index, it is preferable to consider severity potential. In the case of evaluating the severity and frequency of a collision for the test software, even if the test software is temporarily applied to multiple vehicles 1A and 1B, it is difficult to statistically evaluate the severity and frequency of a collision when there are few cases in which a collision actually occurs. Therefore, the test software evaluation unit 97d may estimate a rate of serious collisions having a high severity from the occurrence rate of proper precursor events such as a near collision and a collision with a low severity.

The distribution and sensitivity of the collision type may be different between an automated driving system and a human driver. Therefore, in the statistical evaluation of the safety metric for the test software, the evaluation may be performed after the vehicle 1 to which the test software is applied is classified into an automated driving vehicle of level 3 or higher and the vehicle 1 driven by a human user.

The test software evaluation unit 97d may have a functionality of selecting one piece of optimum test software from multiple pieces of test software. The optimum test software may be test software with the highest safety. The test management unit 97a may determine the test software selected by the test software evaluation unit 97d as formal software to be formally adopted.

When the multiple pieces of test software are an improved version of conventional software that is currently formally applied to each of the vehicles 1A and 1B, the test software evaluation unit 97d may execute a relative evaluation of the selected test software relative to the conventional software. The test software evaluation unit 97d may determine that the selected test software does not have higher capability than the conventional software. In this case, the test management unit 97a may exclude all of the multiple pieces of test software from formal software to be formally adopted.

On the other hand, the test software evaluation unit 97d may not have a functionality of selecting the optimum test software. In this case, the test management unit 97a presents a comparison result of an evaluation index to the test administrator through the HMI of the server 96, and receives an input operation of the selection result of the formal software to be formally adopted by the test administrator. In accordance with this input operation, the test management unit 97a determines the formal software.

The software distribution unit 97b may distribute the formal software to each of the vehicles 1A and 1B belonging to the vehicle population based on the determination of the formal software. The distribution destination vehicle may include a vehicle that belongs to the vehicle population and is not the test target vehicle. The software distribution unit 97b may request another management system to adopt the selected software or recommend the selected software to the other management system.

### Configuration Example of Driving System in Management System

The vehicles 1A and 1B belonging to the vehicle population are equipped with individual driving systems 2A and 2B, respectively. The driving systems 2A and 2B implement a software management functionality in addition to the perception functionality, the planning functionality, and the acting functionality. The driving systems 2A and 2B may each include the participation state management unit 81, the software application unit 82, the operation measurement unit 83, and an HMI cooperation unit 84 as processing units for implementing functionalities by the processor 57b of the software management device 57 executing a computer program.

The participation state management unit 81 manages test participation states of the vehicles 1A and 1B equipped with the respective driving systems 2A and 2B. The test participation state may be either a state of participating in the test or a state of not participating in the test. The state of participating in the test may be classified into any one of a state in which the test is being conducted, a state in which the overall stop functionality SFw for the test is enabled, and a state in which the individual stop functionality SFi for the test is enabled.

The participation state management unit 81 sets the test participation state to the state of not participating in the test when consent to participation in the test (hereafter, test consent) has not been acquired from the vehicle user. Under such a setting situation, the participation state management unit 81 prohibits the vehicles 1A and 1B equipped with the participation state management unit 81 from participating in the test.

When the test consent is acquired from the vehicle user, the participation state management unit 81 sets the test participation state to the state of participating in the test. The participation state management unit 81 acquires information on the overall stop functionality SFw for the test from the server 96 through the communication system 43 to determine whether the overall stop functionality SFw is enabled. The participation state management unit 81 controls enabling and disabling of the individual stop functionality SFi of the vehicles 1A and 1B equipped with the participation state management unit 81, and reflects the result in the test participation state.

The software application unit 82 manages application of software implemented in the driving systems 2A and 2B. The application of the software here may include download and installation of the software, that is, standby-ready for making the software usable. The management of application of software may include defense against an external attack that exploits security vulnerability, management of privacy in software, and management of software update. The update management may include version management of software.

When the update information is acquired from the server 96 and the formal software is distributed from the server 96, the software application unit 82 permanently applies the formal software to the driving systems 2A and 2B. The permanent application here means application until the next update of the formal software.

The management of the application of software may include management of the application of test software. When the vehicles 1A and 1B are selected as the test target vehicles, the software application unit 82 temporarily applies the test software downloaded from the server 96 to the driving systems 2A and 2B, and starts verification of the test software.

In the following, two methods will be exemplified as methods of applying test software when test software, which is an improved version of conventional software already applied to the hardware of the driving systems 2A and 2B, is tested. The hardware may be, for example, the memory 51a of the computer 51 or the memory 53a of the risk checker 53. When a test related to a rule set, a scenario structure, or the like is conducted, the hardware may be the rule DB 58, the scenario DB 59, or the like.

A first method is a method of rewriting conventional software with test software along with conduction of the test. This method is preferable when there is no margin in the hardware resources of the driving systems 2A and 2B. In this method, the test software can be tested under almost the same conditions as in actual operation.

In the first method, when at least one of the overall stop functionality SFw and the individual stop functionality SFi is enabled in a state in which the test software is applied, the software application unit 82 downloads the conventional software from the server 96 and writes the test software back to the conventional software.

The second method is a method in which the conventional software is left, and the test software is additionally downloaded and caused to coexist with the conventional software. In this case, the hardware that stores the test software may be the same hardware as the hardware that stores the conventional software or may be another hardware. The other hardware may be the memory 57a of the software management device 57, or may be hardware provided exclusively for test (for example, hardware dedicated to a shadow-mode). This method is preferable when there is a relatively large margin in the hardware resources of the driving systems 2A and 2B.

In the second method, it is preferable that one software is enabled and the other software is disabled by a software switching functionality in the coexistence state between the conventional software and the test software. For example, when both the overall stop functionality SFw and the individual stop functionality SFi are disabled, the software application unit 82 disables the conventional software and enables the test software. When at least one of the overall stop functionality SFw and the individual stop functionality SFi is enabled, the software application unit 82 enables the conventional software and disables the test software. The software switching functionality can be easily implemented by incorporating an instruction for conditional branching such as an IF statement into a computer program for controlling software.

The driving systems 2A and 2B may not execute the calculation of the disabled software at all. On the other hand, the driving systems 2A and 2B may execute the calculation itself of the disabled software, but may not reflect the calculation result in other functionalities that affect the behavior of the vehicles 1A and 1B, such as the DDT.

The test using the shadow-mode may be conducted while the conventional software is fixed in the enabled state and the test software is fixed in the disabled state. In this case, the calculation result of the disabled test software may be stored exclusively in the storage medium 55c, the management DB 96c, or the like of the recording device 55 for verification of the test software without being reflected in other functionalities that affect the behavior of the vehicles 1A and 1B, such as the DDT. In the following description, it is assumed that the second method is employed.

The operation measurement unit 83 measures an operation result of the temporarily applied test software. The measurement target is at least one of an evaluation index designated from the server 96 side and data necessary for calculation of the evaluation index. When the calculation is executed in the disabled test software as described above, the measurement target may include the calculation result of the disabled test software. The measurement of the operation result may be constantly conducted according to the properties of the evaluation index, or may be conducted only in a predetermined case based on a preset trigger.

The operation measurement unit 83 transmits results of the test obtained by the measurement to the server 96. The results of the test may be sequentially transmitted in the progress of the test, or may be collectively transmitted at the end of the test period. The results of the test include at least one of the participation state set by the participation state management unit 81, the test software application information to the driving systems 2A and 2B by the software application unit 82, and the measurement information measured by the operation measurement unit 83. The test software application information may include a date and time and a period when the test software is applied to the driving systems 2A and 2B, a method of applying the test software to the driving systems 2A and 2B, and the like. The measurement information is information on the measurement target described above.

The operation measurement unit 83 may record the results of the test in the storage medium 55c. A transmission log to the server 96 may be recorded in the storage medium 55c together with the results of the test.

As described above, the operation measurement unit 83 selects an index or data to be measured and an acquisition source from which the index or data is acquired, that is, a measurement target, based on the information of the evaluation index received from the server 96. Then, the operation measurement unit 83 generates the measured index or data in the form of measurement information according to a preset format. This format may be designated from the server 96 in the information of the evaluation index. The generated measurement information can be transmitted to the server 96 as probe data and recorded in the storage medium 55c as described above.

The HMI cooperation unit 84 cooperates with the HMI device 70 to implement a functionality of acquiring the consent described above, a functionality of executing information presentation related to software management, and a functionality of receiving feedback of the vehicle user.

The HMI cooperation unit 84 may attempt to acquire test consent from a vehicle user (for example, a driver) in accordance with a request from the participation state management unit 81. Specifically, the HMI cooperation unit 84 uses the information presentation device 70b to issue notification for requesting test consent to the vehicle user (for example, the driver). The HMI cooperation unit 84 receives an operation input to the operation input device 70a by the driver corresponding to the notification, and confirms the driver's intention of consent. The HMI cooperation unit 84 provides the software application unit 82 with the information indicating that the consent has been acquired from the driver. The HMI cooperation unit 84 issues a notification necessary for the conduction of the test, such as at the start, during the execution, or at the end of the test, to the vehicle user. When these notifications are issued by display using, for example, the CID 70b2 in the HMI device 70, it is easy for the vehicle user to perceive the notifications.

The HMI cooperation unit 84 receives the feedback of the vehicle user during the test execution and at the end of the test period. The feedback may be received by an input operation to the CID 70b2, or may be received by an input of a voice of the vehicle user in the feedback device 70a1.

In the following, multiple usage examples of the overall stop functionality SFw and the individual stop functionality SFi by the management system MS will be described.

### Example of Coping with Erroneous Operation of Vehicle User

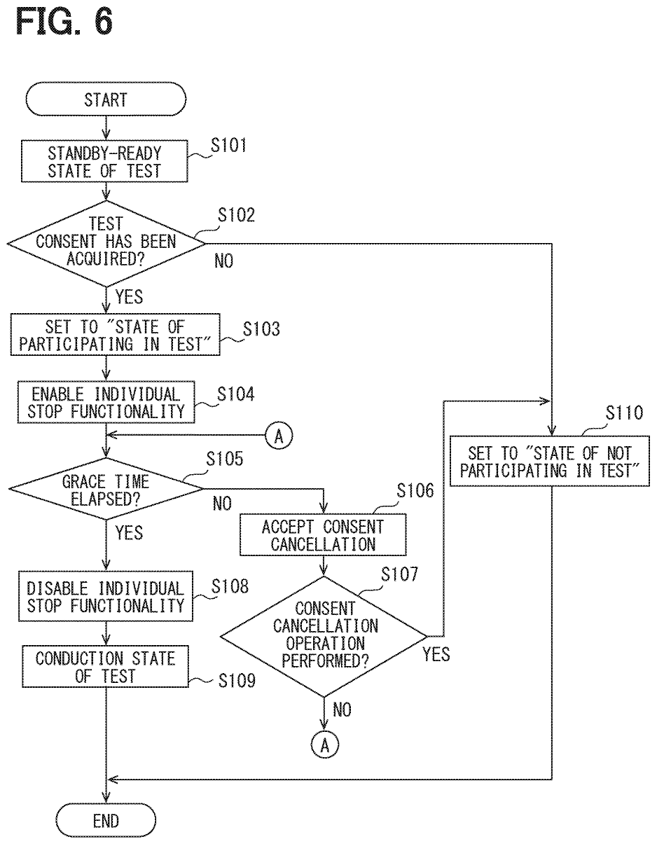

As illustrated in a flowchart of FIG. 6, the management system MS uses the individual stop functionality SFi of the test stop unit MS2 in order to appropriately cope with an erroneous operation of the vehicle user who indicates the intention to participate in the test. The erroneous operation here means an operation of the vehicle user who erroneously agrees with the test. The operation of the vehicle user who agrees with the test is an example of an operation of indicating an intention to participate in the test.

In the series of processes in the method of FIG. 6, for example, the processor 96b of the server 96 executes a computer program stored in the memory 96a. In response to this, in the driving systems 2A and 2B, the processor 53b of the software management device 57 executes the computer program stored in the memory 53a. A trigger for starting this process may be given by an input operation to a user interface in the server 96 of the test administrator.

In the first S101, the server 96 (for example, the test management unit 97a) sets a standby-ready state of the planned test. Based on the setting, a process for conducting the test is started in the server 96 and each of the driving systems 2A and 2B. After the process in S101, the process proceeds to S102. Hereafter, the specific driving system 2 will be described.

In S102, the driving system 2 (for example, the participation state management unit 81 and the HMI cooperation unit 84) attempts to acquire the test consent of the vehicle user and determines whether the test consent has been acquired. If Yes, the process proceeds to S103. If No, the process proceeds to S110.

In S103, the driving system 2 (for example, the participation state management unit 81) sets the participation state of the vehicle 1 to the “state of participating in the test”. After the process in S103, the process proceeds to S104.

In S104, the driving system 2 (for example, the participation state management unit 81) enables the individual stop functionality SFi of the corresponding vehicle 1. Accordingly, the vehicle 1 is in a state in which the test is not started, until the individual stop functionality SFi is disabled. After the process in S104, the process proceeds to S105.

In S105, the driving system 2 (for example, the participation state management unit 81) determines whether a preset grace period has elapsed. The grace period is a preset period, for example, one minute, starting from a timing at which the vehicle user executes the operation of agreeing to the test. If No, the process proceeds to S106. If Yes, the process proceeds to S108.

In S106, the driving system 2 (for example, the participation state management unit 81 and the HMI cooperation unit 84) receives an operation of canceling consent of the vehicle user. After the process in S106, the process proceeds to S107. In S107, the driving system 2 (for example, the participation state management unit 81) determines whether an operation of canceling consent has been performed. If Yes, the process proceeds to S110. If No, the process returns to S105.

In S108, the driving system 2 (for example, the participation state management unit 81) disables the individual stop functionality SFi of the corresponding vehicle 1. After the process in S108, the process proceeds to S109.

In S109, the server 96 (for example, the test management unit 97a) or the driving system 2 (for example, the participation state management unit 81) brings the vehicle 1 in which the individual stop functionality is disabled into the test conduction state. That is, the test is started in the vehicle 1. The series of processes is ended after S109.

On the other hand, when the test consent is not acquired in S102 or when it is determined that the operation of canceling the consent is performed in S107, in S110, the driving system 2 (for example, the participation state management unit 81) sets the participation state of the vehicle 1 to a “state of not participating in the test”. That is, it is determined that the test is not conducted in the vehicle 1. The series of processes is ended after S110.

### Example of Coping with Change in Mind of Vehicle User

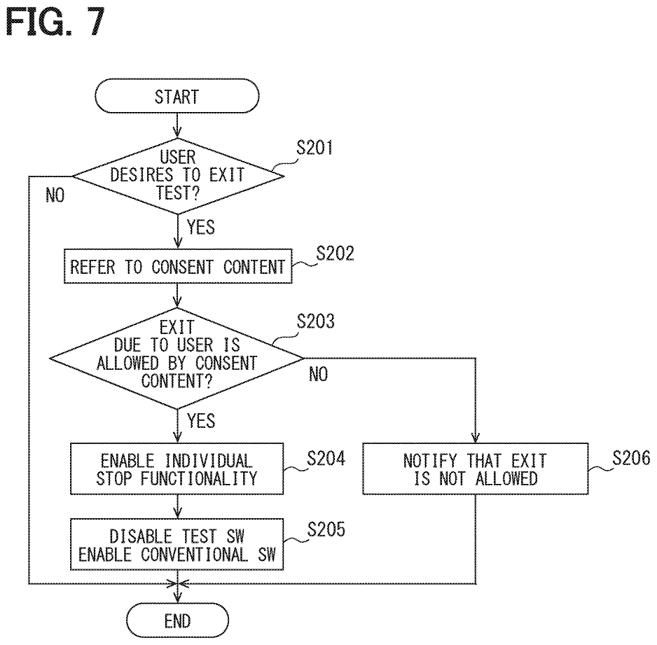

As illustrated in a flowchart of FIG. 7, the management system MS uses the individual stop functionality SFi of the test stop unit MS2 in order to appropriately cope with a change in mind of the vehicle user after the start of the test. In the series of processes in the method of FIG. 7, for example, on the driving system 2 side, the processor 53b of the software management device 57 executes a computer program stored in the memory 53a. In response to this, the processor 96b of the server 96 may execute a computer program stored in the memory 96a. At the start of this process, the test is being executed, and the individual stop functionality SFi for the specific driving system 2 to be processed is disabled. A trigger for starting this process may be given by an input operation to the operation input device 70a by the vehicle user.

In the first S201, the driving system 2 (for example, the participation state management unit 81) determines whether the vehicle user desires to exit the test based on, for example, the above-described input operation. If Yes, the process proceeds to S202. If No, the series of processes is ended.

In S202, the driving system 2 (for example, the participation state management unit 81) refers to the consent content. When the consent content is managed by the test management unit 97a, the consent content is acquired from the server 96 through the communication system 43. After the process in S202, the process proceeds to S203.

In S203, the driving system 2 (for example, the participation state management unit 81) determines whether the consent content allows the exit due to the vehicle user. If Yes, the process proceeds to S204. If No, the process proceeds to S206.

In S204, the driving system 2 (for example, the participation state management unit 81) enables the individual stop functionality SFi. After the process in S204, the process proceeds to S205.

In S205, the driving system 2 (for example, the software application unit 82) disables the test software and enables the conventional software in response to the enabling of the individual stop functionality SFi. The series of processes is ended after S205.

In S206, the driving system 2 (for example, the HMI cooperation unit 84) notifies, through the information presentation device 70b, the vehicle user that the exit of the test is not allowed. In this notification, the actual consent content may be presented to the vehicle user. The series of processes is ended after S206.

### Example of Coping with Conventional Functionality or Conventional Capability that cannot be Exhibited Due to Test Software

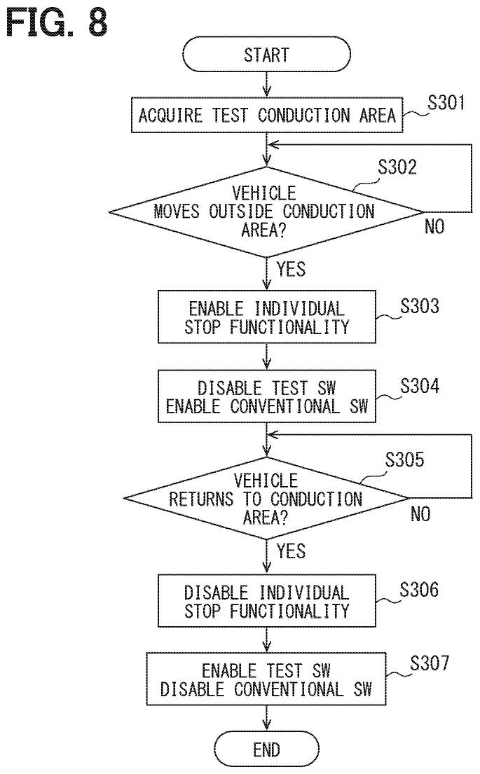

As illustrated in a flowchart of FIG. 8, when there is a conventional functionality or a conventional capability that cannot be exhibited due to the test software, the management system MS uses the individual stop functionality SFi of the test stop unit MS2 in order to exhibit the conventional functionality or the conventional capability of the vehicle 1.

For example, it is assumed that the test software supports only the road traffic act of one country while the conventional software supports the road traffic act of multiple countries across national borders, and the test management unit 97a limits the test conduction area itself. In this case, when the vehicle 1 moves out of the conduction area, the functionality of the conventional software is necessary.

In the series of processes in a method illustrated in FIG. 8, for example, on the driving system 2 side, the processor 53b of the software management device 57 executes a computer program stored in the memory 53a. In response to this, the processor 96b of the server 96 may execute a computer program stored in the memory 96a. It is assumed that the test is being conducted at the start of this process, and the individual stop functionality SFi for the specific driving system 2 to be processed is disabled. In other words, the test software is enabled, and the conventional software is disabled. It is assumed that the test management unit 97a functioning as the test conduction unit MS1 restricts the test conduction area to a specific country. The specific country is a country where the driver of the vehicle 1 resides.

In the first S301, the driving system 2 (for example, the participation state management unit 81 functioning as the test stop unit MS2) acquires information on the test conduction area set by the test management unit 97a. After the process in S301, the process proceeds to S302.

In S302, the driving system 2 (for example, the participation state management unit 81) determines whether the vehicle 1 has moved out of the conduction area. If Yes, the process proceeds to S303. If No, the process in S302 is executed again after a predetermined time.

In S303, the driving system 2 (for example, the participation state management unit 81) enables the individual stop functionality SFi. After the process in S303, the process proceeds to S304.

In S304, the driving system 2 (for example, the software application unit 82) disables the test software and enables the conventional software in response to the enabling of the individual stop functionality SFi. After the process in S304, the process proceeds to S305.

In S305, the driving system 2 (for example, the participation state management unit 81) determines whether the vehicle 1 has returned into the conduction area. If Yes, the process proceeds to S306. If No, the process in S305 is executed again after a predetermined time.

In S306, the driving system 2 (for example, the participation state management unit 81) disables the individual stop functionality SFi. After the process in S306, the process proceeds to S307.

In S307, the driving system 2 (for example, the software application unit 82) disables the conventional software and enables the test software in response to the enabling of the individual stop functionality SFi. The series of processes is finished after S307. During the test conduction, the process of changing the individual stop functionality SFi according to the position of the vehicle 1 is repeated. That is, after the process in S307, the process in S302 may be executed again after a predetermined time.

The test conduction area may be set based on legal constraints on the conduction of the market test or other circumstances. The conduction area may be limited to a special economic zone where conduction of a market test is permitted. A highly confidential area such as a military facility may be excluded from the conduction area. When the test software is not suitable for a test in an urban area with a high traffic volume, only a suburban area with a low traffic volume may be a conduction area.

### Example of Coping with Unsolved Issues of Test Software

The management system MS selectively uses the overall stop functionality SFw and the individual stop functionality SFi of the test stop unit MS2 in order to appropriately cope with unsolved issues of the test software. In the management system MS, the test stop unit MS2 monitors one or more metrics for stop functionality determination when the test software is being tested on open roads. The metric may be the same as or different from an evaluation index for performing an evaluation by the test software evaluation unit 97d. The metric is an index for determining whether the test can be safely continued, and therefore, the metric is preferably an index related to the safety described above.

The test stop unit MS2 sets one or more thresholds in advance for the one or more monitored metrics. The threshold defines an allowable range of the metric. The threshold may be set based on, for example, a boundary for distinguishing between a safe state and an unsafe state. The test stop unit MS2 determines that the metric is out of the acceptable range based on the threshold, and selectively enables the overall stop functionality SFw and the individual stop functionality SFi according to the determination. The fact that the metric is out of the acceptable range based on the threshold is an example of stop conditions.

The stop conditions may be separated into an individual stop condition and an overall stop condition, and may be operated separately. In order to selectively enable the overall stop functionality SFw and the individual stop functionality SFi, for example, in each vehicle 1 that is a test target vehicle, a metric for determining an individual stop condition may be monitored based on a condition of individual stop for enabling the individual stop functionality SFi in a vehicle unit. Whether to enable the individual stop functionality SFi may be determined by self-diagnosis performed by the participation state management unit 81 of each vehicle 1, or may be determined by the test management unit 97a of the server 96 that has received a monitoring result. The metric and the threshold used for the self-diagnosis may be common to test target vehicles participating in the same test. On the other hand, the server 96 may monitor the metric for determining the overall stop condition based on the overall stop condition for enabling the overall stop functionality SFw.

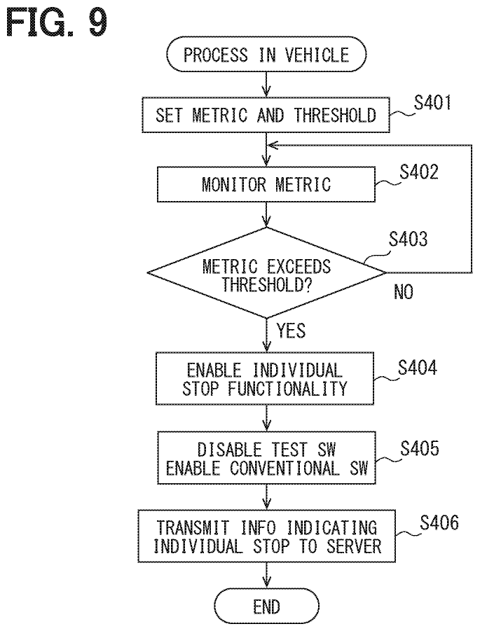

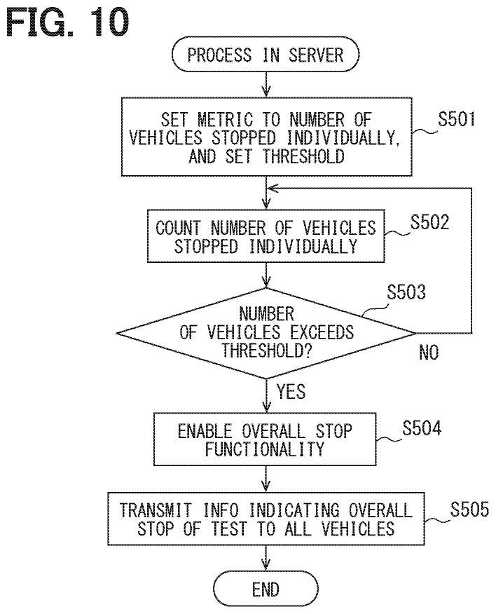

Methods illustrated in the flowchart in FIGS. 9 and 10 will be described below as examples of coping with the unsolved issues. In a series of processes in FIG. 9, the processor 53b of the software management device 57 of the driving system 2 in each vehicle 1 functions as the test stop unit MS2 and executes the computer program stored in the memory 53a. The series of processes in FIG. 9 is started in accordance with, for example, the test start timing of each vehicle 1. In a series of processes in FIG. 10, the processor 96b of the server 96 functions as the test stop unit MS2 and executes a computer program stored in the memory 96a. The series of processes in FIG. 10 is started at the timing when the server 96 determines that the test needs to be started as a whole, for example.

In the first S401 in FIG. 9, the driving system 2 (for example, the participation state management unit 81) sets one or more metrics used for the individual stop conditions and thresholds thereof. This setting may be executed by acquiring setting of the metric and the threshold thereof determined by the test management unit 97a of the server 96. This setting may be obtained by acquiring the setting determined by the test management unit 97a and partially changing the setting based on an individual specification and an individual traveling environment of the vehicle 1. After the process in S401, the process proceeds to S402.

One or more metrics may include the number of error occurrences of software. The error of software may include a failure in software and a defect in software. The error of the software may be the number of times the software itself has output a diagnostic code, or may be the number of times the driving system 2 detects the abnormality of the software. The number of error occurrences of software may be only the number of error occurrences of test software, may be the number of error occurrences including software directly related to the test software, or may be the number of error occurrences of all pieces of software of the driving system 2. The software directly related to the test software is, for example, software that executes a process by directly referring to the output of the test software. Instead of the number of error occurrences, a function obtained by weighting the error occurrence with one or both of the importance and the urgency of the error may be adopted as the metric.

The one or more metrics may include an error indicating a decrease in capability. The capability here may be general capability. When the test software is software that electronically controls a damper provided in the motion actuator 60, the error may be a value indicating the occurrence of abnormal shaking of the vehicle 1 during curve traveling. When the test software is software that implements an image perception functionality of a camera as the external environment sensor 41, the error may be a value indicating a decrease in an object perception rate with respect to disturbance due to bad weather or the like.

The one or more metrics may be the number of violations of the safety determination. The violation of the safety determination may be a violation of a safety envelope or a violation of a safety distance. When the violation of the safety determination is determined such that the collision risk exceeds the risk threshold, a function weighted with one or both of the importance and the urgency of the violation may be adopted as the metric instead of the number of violations. When the violation of the safety determination is determined such that the rule stored in the rule set includes the violation of the vehicle 1, a function weighted with one or both of the importance and the urgency of the violation may be adopted as the metric instead of the number of violations. That is, the violation metric described above may be adopted as the metric used for the individual stop condition. The one or more metrics may include the number of times the monitoring of the behavior of the vehicle 1 operated by the driving system 2 according to the driving policy fails.

In S402, the driving system 2 (for example, the participation state management unit 81) continuously monitors the metric set in S401. After the process in S402, the process proceeds to S403.

In S403, the driving system 2 (for example, the participation state management unit 81) determines whether the monitored metric exceeds the threshold set in S401. That is, it is determined whether the individual stop condition is satisfied. When multiple metrics are set, whether all of the metrics need to exceed the corresponding thresholds in the S401 or one or some of the metrics need to exceed the corresponding thresholds is set in advance, and the determination may be conducted according to such condition setting. If Yes, the process proceeds to S404. If No, the process returns to S402, and the loop process in S402 and S403 is repeated until the test period ends.

In S404, the driving system 2 (for example, the participation state management unit 81) enables the individual stop functionality SFi. After the process in S404, the process proceeds to S405.

In S405, the driving system 2 (for example, the software application unit 82) disables the test software and enables the conventional software in response to the enabling of the individual stop functionality SFi. After the process in S405, the process proceeds to S406.

In S406, the driving system 2 (for example, the participation state management unit 81) transmits, to the test management unit 97a of the server 96, information indicating that the test has been individually stopped in the vehicle 1 equipped with the driving system 2. At the same time, the reason for the individual stop of the test may be transmitted, or metric monitoring data may be transmitted. The series of processes is ended after S406.

Next, a process in the server 96 corresponding to the process in the vehicle 1 in FIG. 9 will be described with reference to FIG. 10. In the first S501, the server 96 (for example, the test management unit 97a) sets one or more metrics used for the overall stop conditions and thresholds thereof. The metric may be, for example, the number of vehicles 1 in which the test is individually stopped by self-diagnosis during the test conduction. Instead of the number of vehicles, the metric may be a proportion of vehicles 1 in which the test has been stopped individually to all the test target vehicles, that is, an individual stop ratio. In the following, the description will be continued assuming that the metric is the number of vehicles. After the process in S501, the process proceeds to S502.

In S502, the server 96 (for example, the test management unit 97a) counts, based on the information received from the vehicles 1 by the process in S406, the number of vehicles in which the test is individually stopped. After the process in S502, the process proceeds to S503.

In S503, the server 96 (for example, the test management unit 97a) determines whether the number of vehicles counted in S502 exceeds a threshold. That is, it is determined whether the overall stop condition is satisfied. If Yes, the process proceeds to S504. If No, the process returns to S502, and the loop process in S502 and S503 is repeated until the test period ends.

In S504, the server 96 (for example, the test management unit 97a) enables the overall stop functionality SFw. After the process in S504, the process proceeds to S505.

In S505, the server 96 (for example, the test management unit 97a) transmits to all the test target vehicles information indicating that the test is stopped as a whole. In the vehicles 1 that have received the message transmitted in S505, the participation state management unit 81 enables the overall stop functionality SFw.

The transmission destination may include the vehicle 1 in which the individual stop functionality is already enabled. This is because, when the individual stop functionality SFi is disabled again based on some triggers, and the participation state management unit 81 of the vehicle 1 does not perceive that the overall stop functionality SFw is enabled, the test may be resumed in the vehicle 1. The series of processes is ended after S505.

### Summary

According to the first embodiment described above, the individual stop functionality SFi and the overall stop functionality SFw of the participation unit can be selectively used. Therefore, the test can be stopped in an appropriate form in consideration of the validity and usability of the test operation.

Particularly, according to the first method described above in the first embodiment, in the test standby-ready state, the conventional software applied to the hardware provided in the driving system 2 as a vehicle system corresponding to the participation unit is rewritten to the test software downloaded from the server 96 to the driving system 2. When a specific participation unit individually stops the test by the individual stop functionality SFi, the conventional software is downloaded from the server 96, and the software for the test is written back to the conventional software. The test can be conducted and stopped with less hardware resources by rewriting and writing-backing according to the start and stop of the test.

Particularly, according to the second method described above in the first embodiment, in the standby-ready state, the test software is downloaded from the server 96 to the hardware provided in the driving system 2 corresponding to the participation unit, separately from the conventional software. Both the conventional software and the software for the test remain in the hardware in a state in which one or both of the conventional software and the software for the test can be enabled. When the participation unit stops the test, the conventional software is enabled, and the software for the test is disabled while both of them remain in the hardware. In this way, when the vehicle 1 stops the test, the software for the test remains in the hardware provided in the driving system 2, and thus it is easy to resume the test. The state of the software during conduction of the test is stored, and therefore, the test can be easily verified later. Therefore, the test can be stopped in an appropriate form.

According to the first embodiment, in the individual stop functionality SFi in the standby-ready state, when the participation unit executes, through the HMI device 70, the operation of indicating an intention to participate in the test, the test of the participation unit is stopped without being started until the grace period during which the operation of indicating an intention to participate can be canceled elapses. Therefore, even when the participation unit erroneously operates the operation of indicating an intention to participate, the influence of the test on the behavior or the like of the vehicle 1 against the actual intention can be restricted.

According to the first embodiment, consent is acquired from the specific participation unit that the participation in the test cannot be canceled during the predetermined period, and the individual stop functionality SFi for the specific participation unit is fixed to the disabled state during the predetermined period. The test can be efficiently operated, and the driving system 2 can be improved quickly by avoiding easy enabling of the individual stop functionality SFi.

According to the first embodiment, a test conduction area is set. When a specific vehicle among the multiple vehicles moves out of the conduction area in the test conduction state, the participation unit corresponding to the specific vehicle individually stops the test as the individual stop functionality SFi. That is, the entire test can be restricted from being stopped along with the movement of only some vehicles to the outside of the conduction area. Therefore, the test can be efficiently operated, and the driving system 2 can be improved quickly.

According to the first embodiment, when the specific vehicle among the multiple vehicles satisfies the individual stop condition, the participation unit corresponding to the specific vehicle individually stops the test as the individual stop functionality SFi. When the overall stop condition is satisfied, the test is stopped as a whole as the overall stop functionality. The individual stop functionality SFi and the overall stop functionality can be separately used under different enabling conditions, and therefore, the test can be stopped in an appropriate form.

According to the first embodiment, the overall stop condition is that the number of vehicles or the vehicle proportion of vehicles that have individually stopped the test among the multiple vehicles 1 is equal to or greater than the predetermined threshold. The test can be stopped stepwise by associating the overall stop condition with the individual stop functionality, and therefore, the validity of the test process can be improved.

According to the first embodiment, in the vehicle unit, it is determined whether to individually stop the test using the metric, and as a whole, it is determined whether to stop the test as a whole based on the situations of multiple vehicles 1. The test can be stopped in an appropriate form by determining the stop functionality stepwise in this manner.

### Second Embodiment

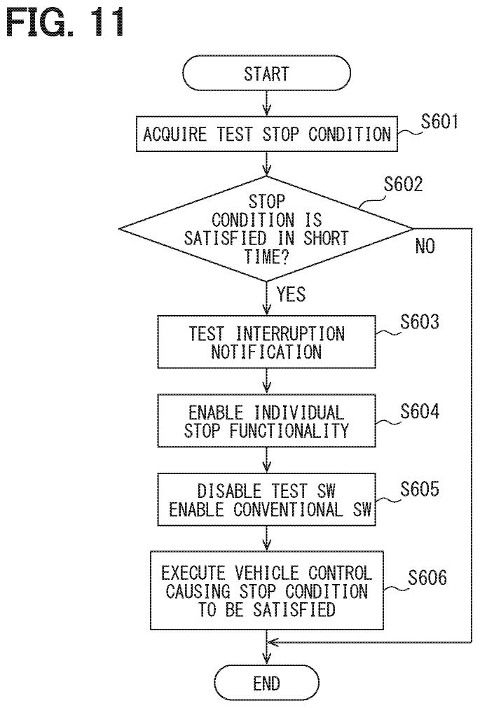

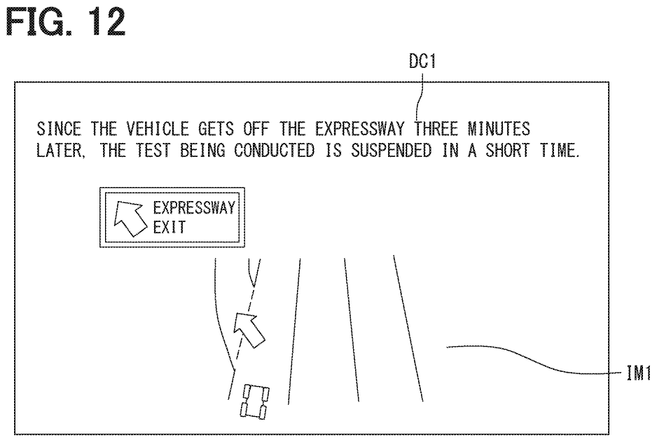

As illustrated in FIGS. 11 and 12, a second embodiment is a modification example of the first embodiment. The second embodiment will be described focusing on a difference from the first embodiment.

In the second embodiment, the HMI cooperation unit 84 cooperates with the participation state management unit 81 to issue a notification to the vehicle user at a proper timing. Therefore, the software management device 57 functions as a notification control device that controls the issuance of the notification about the test.

In the series of processes illustrated in the flowchart in FIG. 11, the processor 53b of the software management device 57 of the driving system 2 functions as the test stop unit MS2 and executes a computer program stored in the memory 53a. The series of processes in FIG. 11 is repeatedly executed at predetermined intervals during the test conduction.

In the first S601, the driving system 2 (for example, the participation state management unit 81) acquires a condition for individually stopping the test. The individual stop condition here includes a test conduction area, and the test is conducted only on an expressway. The individual stop condition may be linked with the ODD. For example, when the condition under which the level 3 automated driving can be executed is limited to an expressway, the test conduction area substantially matches the ODD. After the process in S601, the process proceeds to S602.

In S602, the driving system 2 (for example, the participation state management unit 81) determines whether to satisfy the individual stop condition in a short time. For example, when the vehicle 1 is traveling on an expressway, it is determined whether the vehicle 1 is scheduled to get off the expressway in a short time. The term “short time” may mean, for example, being within a preset time such as 5 minutes later. That is, it may be determined whether the possibility that the individual stop condition is satisfied within a preset time is equal to or greater than a predetermined threshold. If Yes, the process proceeds to S603. If No, the series of processes is ended.

In S603, the driving system 2 (for example, the HMI cooperation unit 84) issues a test interruption notification to the vehicle user (for example, the driver) using the information presentation device 70b. The test interruption notification may include the notification that the test is to be interrupted in a short time and a reason why the test is to be interrupted.

For example, as illustrated in FIG. 12, a text content of “Since the vehicle gets off the expressway three minutes later, the test being conducted is suspended in a short time” may be displayed on a screen of CID 70b2 together with an image of the route guidance. After the process in S603, the process proceeds to S604.

In S604, the driving system 2 (for example, the participation state management unit 81) enables the individual stop functionality SFi. After the process in S604, the process proceeds to S605.

In S605, the driving system 2 (for example, the software application unit 82) disables the test software and enables the conventional software in response to the enabling of the individual stop functionality SFi. After the process in S605, the process proceeds to S606.

In S606, the driving system 2 (for example, the driving planning unit 22 and the motion control unit 31) executes vehicle control that causes the individual stop condition to be satisfied. For example, the vehicle 1 is guided to an expressway exit by autonomous control and travels to a general road. The series of processes is ended after S606.

The test interruption notification may be issued before the vehicle control that causes the stop condition to be satisfied is executed and the test is actually interrupted. Therefore, in S602, when it is determined that there is a possibility that the vehicle control in S606 is executed before the notification in S603, the participation state management unit 81 may output a suspension request or a delay request of the vehicle control to the driving planning unit 22 and perform an adjustment such that the test interruption notification is issued before the vehicle control. For example, the driving planning unit 22 may control the velocity of the vehicle 1 to be lower to delay the timing of getting off the expressway.

According to the second embodiment described above, before the control of the vehicle 1 that causes the individual stop condition to be satisfied is executed, the adjustment is conducted such that the notification regarding the stop of the test is issued to the vehicle user. With this adjustment, the vehicle user can perceive the stop of the test before the test has to be stopped, and therefore, the validity of the test process can be improved.

### Third Embodiment

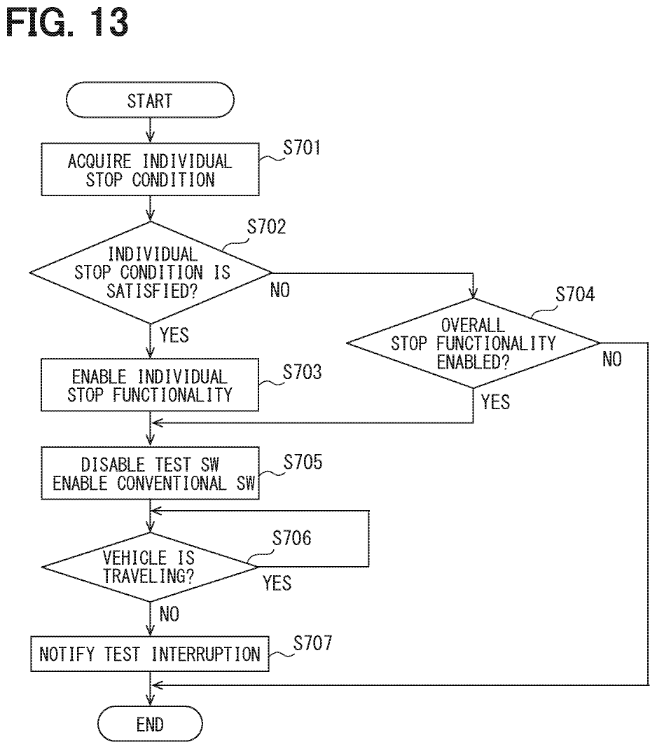

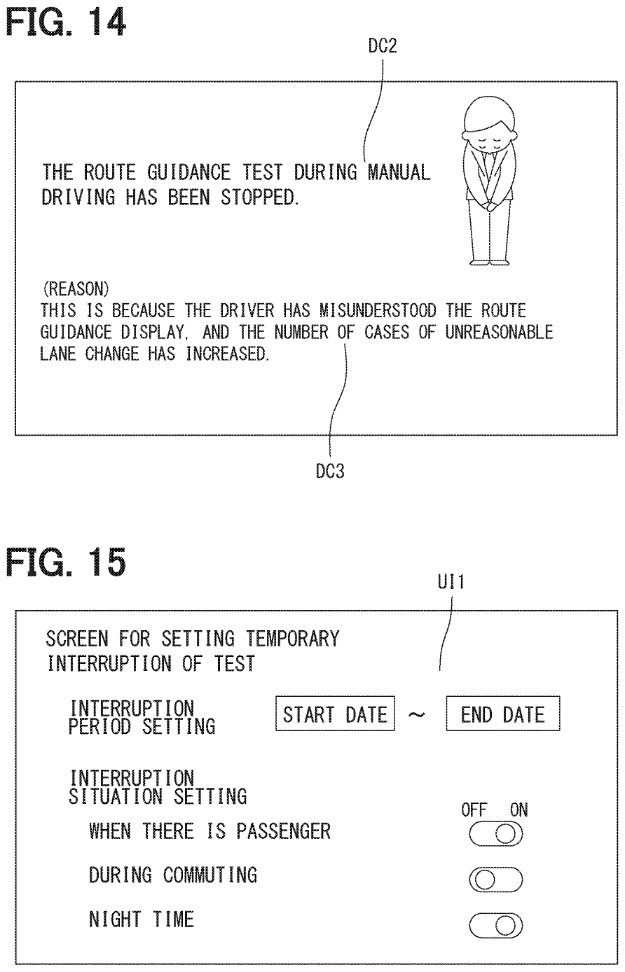

As illustrated in FIGS. 13 and 14, a third embodiment is a modification example of the second embodiment. The third embodiment will be described focusing on a difference from the second embodiment.

In the third embodiment, the HMI cooperation unit 84 issues the test interruption notification at a timing when the traveling of the vehicle 1 is avoided. When the test is conducted during the manual driving by the driver, the adverse effect of the notification on the driving is reduced by avoiding traveling. The test during manual driving by the driver may be, for example, an HMI test for route guidance to a destination for the driver.

In the series of processes illustrated in the flowchart in FIG. 13, the processor 53b of the software management device 57 of the driving system 2 functions as the test stop unit MS2 and executes a computer program stored in the memory 53a. The series of processes in FIG. 13 is repeatedly executed at predetermined intervals during the test conduction.

In the first S701, the driving system 2 (for example, the participation state management unit 81) acquires a condition for individually stopping the test. In S702 after the process in S701, the driving system 2 (for example, the participation state management unit 81) determines whether the individual stop condition is satisfied. If Yes, the process proceeds to S703. If No, the process proceeds to S704.

In S703, the driving system 2 (for example, the participation state management unit 81) enables the individual stop functionality SFi. After the process in S703, the process proceeds to S704.

In S704, the driving system 2 (for example, the participation state management unit 81) acquires a state of the overall stop functionality SFw from the test management unit 97a of the server 96, and determines whether the overall stop functionality SFw is enabled. If Yes, the process proceeds to S705. If No, the series of processes is ended.

In S705, the driving system 2 (for example, the software application unit 82) disables the test software and enables the conventional software in response to enabling of the individual stop functionality SFi or the overall stop functionality SFw. After the process in S705, the process proceeds to S706.

In S706, the driving system 2 (for example, the HMI cooperation unit 84) determines whether the vehicle 1 is traveling. If Yes, the determination in S706 is repeated after the predetermined time elapses. If No, the process proceeds to S707.

In S707, the driving system 2 (for example, the HMI cooperation unit 84) notifies the test interruption to the vehicle user (for example, the driver) using the information presentation device 70b. The test interruption notification may include the notification that the test has been interrupted and the reason why the test has been interrupted.

FIG. 14 illustrates an example of notification when the overall stop functionality SFw is enabled and the test is stopped. On a screen of CID 70b2, a text content of “The route guidance test during manual driving has been stopped.” and a text content of “(reason) This is because the driver has misunderstood the route guidance display, and the number of cases of unreasonable lane change has increased.” may be displayed. After the process in S707, the series of processes is ended.

The HMI cooperation unit 84 may further adjust a timing of issuing the notification in more detail. For example, even when the HMI cooperation unit 84 accepts the notification at a temporary stop timing of the vehicle 1, the notification may be issued at the temporary stop timing with a stop signal while avoiding the temporary stop timing at a stop line. This is because, at the temporary stop timing at the stop line, it is conceivable that the driver concentrates on the periphery monitoring for restart, and that a restart timing is hardly predicted. After the vehicle 1 is parked, the HMI cooperation unit 84 may suspend the issuance of the notification up to the timing at which the vehicle 1 starts traveling again, and may issue the notification at the timing at which the driver gets into the vehicle to restart the traveling or at the timing at which the power switch (ignition switch) of the vehicle 1 is turned on.

According to the third embodiment described above, when the participation unit stops the test, the notification regarding the stop of the test is issued at the timing when traveling of the vehicle 1 is avoided. The notification is issued at a timing at which the vehicle user is likely to concentrate, and therefore, it is easier for the vehicle user to perceive the notification.

### Fourth Embodiment

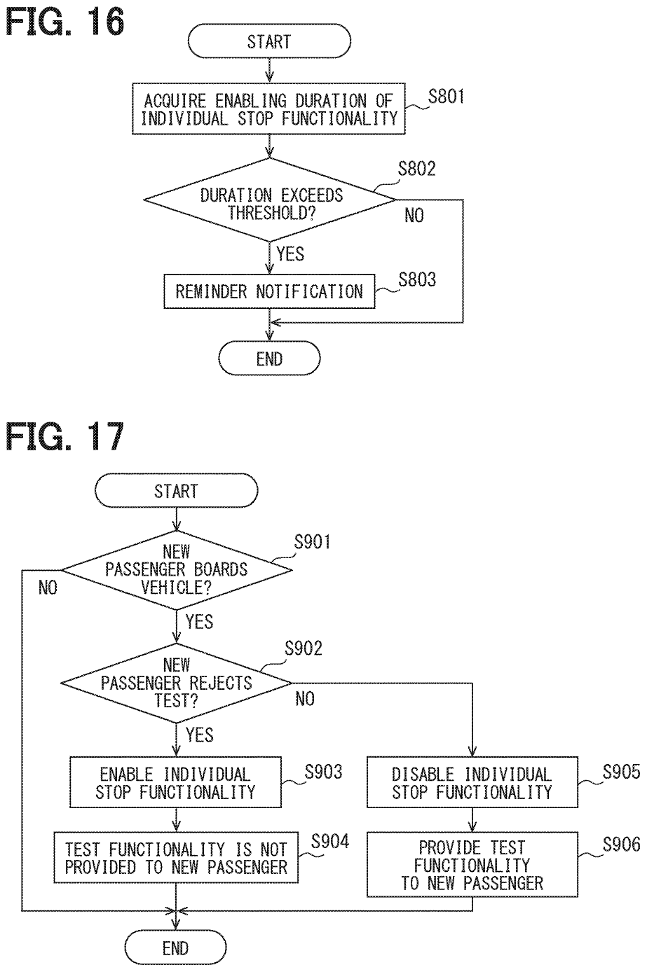

As illustrated in FIGS. 15 and 16, a fourth embodiment is a modification example of the second embodiment. The fourth embodiment will be described focusing on a difference from the second embodiment.

In the fourth embodiment, it is assumed that the consent content of the test includes a policy that allows the vehicle user to freely exit the test temporarily. Therefore, the participation state management unit 81 and the HMI cooperation unit 84 functioning as the test stop unit MS2 provide a functionality that allows the vehicle user to set a form of temporary interruption of the test. The temporary interruption here corresponds to one form of the individual stop functionality SFi.

For example, as illustrated in FIG. 15, the HMI cooperation unit 84 provides a user interface UI1 for the vehicle user to set a form of temporary interruption of the test using, for example, the CID 70b2. The form of temporary interruption includes a form based on a period and a form based on a situation. In the form based on the period, the period during which the vehicle user temporarily suspends the test can be directly set. For example, the vehicle user may set a start date and an end date of the period.

In the form based on the situation, when the corresponding situation occurs, the vehicle user sets whether to temporarily suspend the test. Therefore, it is preferable that multiple situations can be individually set. For example, in FIG. 15, situations such as “when there is a passenger”, “commuting”, and “nighttime” are provided as settable situations by the interface.

For example, when the vehicle user sets the temporary interruption in the situation “when there is a passenger”, the participation state management unit 81 may acquire sensor data of a seating sensor or the like and determine whether there is a passenger. For example, when the vehicle user sets the temporary interruption in the situation “commuting”, the participation state management unit 81 may acquire departure place information and destination information in the route planning and determine whether the departure place or the destination is a work place registered in advance by the vehicle user.

The participation state management unit 81 and the HMI cooperation unit 84 may issue a reminder notification for reminding the vehicle user of the presence of the test when the period of the temporary interruption continues for a predetermined period or longer. For example, in the series of processes illustrated in the flowchart in FIG. 16, the processor 53b of the software management device 57 of the driving system 2 functions as the test stop unit MS2 and executes a computer program stored in the memory 53a. The series of processes in FIG. 16 is repeatedly executed in the temporarily suspended state set by the vehicle user.

In the first S801, the driving system 2 (for example, the participation state management unit 81) acquires the duration of an enabled state of the individual stop functionality SFi. In S802 after the process in S801, the driving system 2 (for example, the participation state management unit 81) determines whether the duration acquired in S801 exceeds a preset threshold (for example, one week). If Yes, the process proceeds to S803. If No, the series of processes is ended.

In S803, the driving system 2 (for example, the HMI cooperation unit 84) issues the reminder notification. The reminder notification may include a notification for prompting the vehicle user to determine whether to continue the test participation or cancel the test participation. The reminder notification may include a notification for re-illustrating the test content.

According to the fourth embodiment described above, in the provided user interface UI1, the vehicle user can set the temporary stop form of the test in the participation unit. Whether to enable the individual stop functionality SFi is determined based on the setting in the user interface UI1. Therefore, usability in the test can be improved.

According to the fourth embodiment, when the duration of the temporary stop based on the setting in the user interface UI1 exceeds the preset period, the reminder notification for reminding the vehicle user of the presence of the test is issued. The possibility that the user who remembers the presence of the test returns to the test can be increased, and therefore, the test can be efficiently operated, and the driving system 2 can be quickly improved.

### Fifth Embodiment

As illustrated in FIG. 17, a fifth embodiment is a modification example of the first embodiment. The fifth embodiment will be described focusing on a difference from the first embodiment.

In the fifth embodiment, a vehicle used for MaaS, for example, a robot taxi, an automated driving bus, or a ride-sharing vehicle, is assumed as the vehicle 1. In the fifth embodiment, the unit of participation in the test is not a vehicle unit but a passenger unit. The passenger unit may be a single passenger unit or a group unit of passengers.

The test in the passenger unit may be a test related to the HMI used by the passenger while riding in the vehicle 1, or may be a test related to a new payment service. The functionality serving as a test target may include a functionality provided in cooperation with the mobile terminal 91, such as a smartphone owned by a passenger, through the communication system 43 or the like.

In the fifth embodiment, the participation state management unit 81 of the driving system 2 checks the intention of each passenger to reject the test, and conducts the test on each passenger based on the intention checking. For example, in the series of processes illustrated in the flowchart in FIG. 17, the processor 53b of the software management device 57 of the driving system 2 functions as the test stop unit MS2 and executes the computer program stored in the memory 53a. The series of processes in FIG. 17 is repeatedly executed at predetermined intervals during the test conduction.

In the first S901, the driving system 2 (for example, the participation state management unit 81) determines whether a new passenger has ridden in the vehicle 1. If Yes, the process proceeds to S902. If No, the series of processes is ended.

In S902, the driving system 2 (for example, the participation state management unit 81) determines whether the new passenger rejects the test. This determination may be conducted by acquiring an indication of intention preset by the passenger in an application used for MssS. This determination may be conducted based on information obtained by checking the intention of a new passenger using the in-vehicle HMI when the new passenger boards the vehicle 1. If Yes, the process proceeds to S903. If No, the process proceeds to S905.

In S903, the driving system 2 (for example, the participation state management unit 81) enables the individual stop functionality SFi for the passenger who is the determination target in S902. In S904 after the process in S903, the driving system 2 (for example, the software application unit 82) does not provide the test functionality to the passenger who is the determination target in S902, and provides only the conventional functionality. The series of processes is ended after S904.

In S905, the driving system 2 (for example, the participation state management unit 81) disables the individual stop functionality SFi for the passenger who is the determination target in S902. In S906 after the process in S905, the driving system 2 (for example, the software application unit 82) provides the test functionality to the passenger who is the determination target in S902. The series of processes is ended after S906.

According to the fifth embodiment described above, the participation unit is set to the passenger unit based on the passenger. The individual stop functionality SFi is enabled for the passenger unit for which the intention to reject the test is confirmed, and the test functionality is provided for the passenger unit for which the intention is not confirmed. The test in the vehicle 1 can be conducted, respecting the intention of the individual passenger, and therefore, usability can be improved.

### Other Embodiments

Although multiple embodiments are described above, the present disclosure is not construed as being limited to these embodiments, and can be applied to various embodiments and combinations within a scope that does not depart from the gist of the present disclosure.

As another embodiment, when the test is conducted using the POV that is the vehicle 1 capable of participating in open road traffic, the unit of participation in the test may be an individual unit. The individual here may include a passenger in addition to the driver.

For example, in the vehicle 1 including displays for a driver seat and a passenger seat and a display for a rear seat, a test related to a display layout of the displays is conducted. When the occupant seated on the rear seat rejects to participate in the test, the test may be conducted only on the displays for the driver seat and the passenger seat. For example, in a test related to the temperature control of a seat heater, the test may be conducted only on a seat on which the occupant who desires to participate sits.

As another embodiment related to the fifth embodiment, the server 96 may be unnecessary for the test system, and the test system may be configured to be completed in a vehicle used for one MaaS. In this case, the driving system 2 may have all the functionalities of the test conduction unit MS1, the test stop unit MS2, and the software management unit MS3. The test stop unit MS2 provided in the driving system 2 may control both the individual stop functionality SFi and the overall stop functionality.

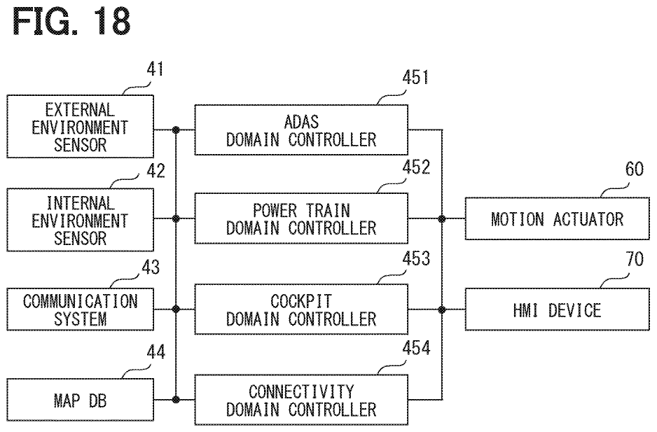

As another embodiment, a configuration of the processing system 50 may be a configuration as shown in FIGS. 17 and 18. For example, in FIG. 18, a configuration including multiple domain controllers 451 to 454 is adopted. Each of the domain controllers 451 to 454 may have the same hardware configuration as the processing system or the ECU of the first embodiment.

The ADAS domain controller 451 aggregates functionalities related to advanced driver-assistance systems (ADAS). The ADAS domain controller 451 may implement a part of the perception functionality, a part of the determination functionality, and a part of the control functionality in a combined manner. A part of the perception functionality implemented by the ADAS domain controller 451 may be, for example, a functionality corresponding to fusion of information sensed by the multiple sensors 40 in the sensing unit 10 of the first embodiment or a simplified functionality thereof. A part of the determination functionality implemented by the ADAS domain controller 451 may be, for example, a functionality corresponding to the prediction unit 21 and the driving planning unit 22 of the first embodiment or a simplified functionality thereof. A part of the control functionality implemented by the ADAS domain controller 451 may be, for example, a functionality of generating request information for the motion actuator 60 among the functionalities corresponding to the motion control unit 31 of the first embodiment.

The power train domain controller 452 aggregates functionalities related to control of a power train. The power train domain controller 452 may implement at least a part of the perception functionality and at least a part of the control functionality in a combined manner. A part of the perception functionality implemented by the power train domain controller 452 may be, for example, a functionality of perceiving an operating state of the driver for the motion actuator 60 among functionalities corresponding to the internal perception unit 13 of the first embodiment. A part of the control functionality implemented by the power train domain controller 452 may be, for example, a functionality of controlling the motion actuator 60 among the functionalities corresponding to the motion control unit 31 of the first embodiment.

The cockpit domain controller 453 aggregates functionalities related to cockpit. The cockpit domain controller 453 may implement at least a part of the perception functionality and at least a part of the control functionality in a combined manner. A part of the perception functionality implemented by the cockpit domain controller 453 may be, for example, a functionality of perceiving a switch state of the HMI device 70 in the internal perception unit 13 of the first embodiment. A part of the control functionality implemented by the cockpit domain controller 453 may be, for example, a functionality corresponding to the HMI output unit 71 of the first embodiment.

The connectivity domain controller 454 aggregates functionalities related to connectivity. The connectivity domain controller 454 may implement at least part of the perception functionality in a combined manner. A part of the perception functionality implemented by the connectivity domain controller 454 may be a functionality of organizing and converting global position data, V2X information, and the like of the ego-vehicle acquired from the communication system 43 in the form that can be used by, for example, the ADAS domain controller 451 and the cockpit domain controller 453.

In this embodiment, when software management is performed by each of the domain controllers 451 to 454 that implement each functionality, the multiple domain controllers 451 to 454 may correspond to “software management units” that form the management system MS or the test system.

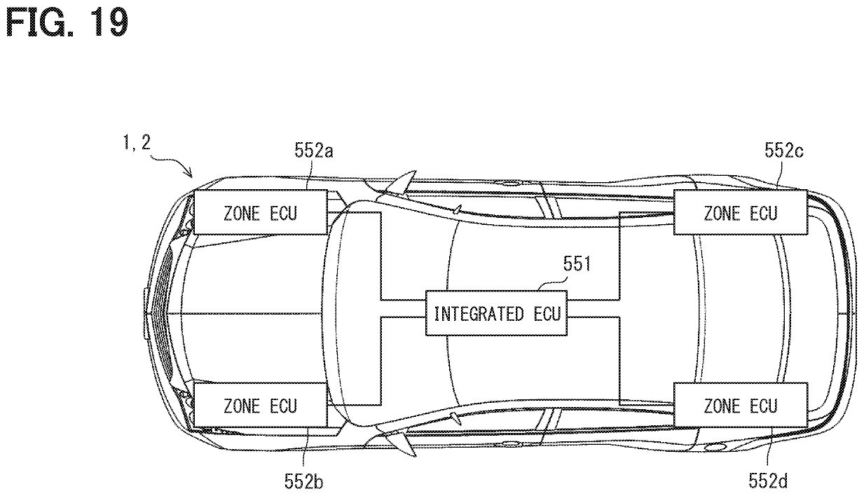

In FIG. 19, a configuration including an integrated ECU 551 and multiple zone ECUs 551a to ECU 551d is adopted. In this configuration, the multiple zone ECUs 551a to ECU 551d execute control of devices, modules, units, apparatuses, and the like disposed in a predetermined assigned zone of the vehicle 1.

The external environment sensor 41 such as a camera disposed in front of the vehicle 1 and the information presentation device 70b such as the CID 70b2 disposed in a cockpit are controlled by the zone ECU 551a or the zone ECU 551b disposed in front of the vehicle 1. For example, the external environment sensor 41 such as a millimeter wave radar disposed on a rear side of the vehicle 1 is controlled by the zone ECU 551c or the zone ECU 551d disposed on the rear side of the vehicle 1.

The integrated ECU 551 aggregates the sensing information and the like from each of the zones ECU 551a to ECU 551d, and performs integrated control of the driving system 2 in each of the zones ECU 551a to ECU 551d. For example, the integrated ECU551 may implement substantially all of the planning functionality and the software management functionality.

As another embodiment, the vehicles 1, 1A, and 1B equipped with the driving systems 2, 2A, and 2B may be right-hand drive vehicles or left-hand drive vehicles. A traffic environment in which the vehicles 1, 1A, and 1B travel may be a traffic environment in which left-hand traffic is the norm or a traffic environment in which right-hand traffic is the norm. The driving systems 2, 2A, and 2B according to the present disclosure may be appropriately optimized in consideration of road traffic laws and customs across countries and regions, police investigations, prosecutions, criminal and civil lawsuits regarding traffic accidents, and the like.

The control unit and the method thereof described in the present disclosure may be implemented by a dedicated computer constituting a processor programmed to execute one or multiple functionalities embodied by a computer program. Alternatively, the device and the method thereof according to the present disclosure may be implemented by a dedicated hardware logic circuit. Alternatively, the device and the method thereof according to the present disclosure may be implemented by one or more dedicated computers implemented by a combination of a processor that executes a computer program and one or more hardware logic circuits. The computer program may be stored in a computer-readable non-transient tangible storage medium, as an instruction executed by a computer.

### Disclosure of Technical Ideas

The present disclosure discloses multiple technical ideas described in multiple items listed below.

### Technical Idea 1

A test system for testing a vehicle system (2, 2A, 2B) mounted on each of one or more vehicles (1, 1A, 1B) that are allowed to participate in open road traffic, includes a test conduction unit (MS1) configured to set and conduct a test, and a test stop unit (MS2) having both an individual stop functionality (SFi) for individually stopping the test in a participation unit in a standby-ready state or a conduction state of the test and an overall stop functionality (SFw) for stopping the test as a whole in the standby-ready state or the conduction state of the test.

### Technical Idea 2

A test system is used for testing, using multiple vehicles (1, 1A, 1B) that are allowed to participate in open road traffic, a vehicle system (2, 2A, 2B) mounted on each of the vehicles. The test system includes: each of the vehicle systems; and a server (96) communicably connected to each of the vehicle systems. In each of the vehicles, each of the vehicle systems determines, by using one or more metrics, whether to enable an individual stop functionality of individually stopping a test in a vehicle unit. The server determines, based on a situation of the individual stop functionality being enabled in the multiple vehicles, whether to enable an overall stop functionality of stopping the test as a whole.

According to such a technical idea, in each vehicle system, whether to individually stop the test is determined using the metric, and in the server, whether to stop the test as a whole is determined based on the situation of the multiple vehicles. The test can be stopped in an appropriate form by determining the stop functionality stepwise in this manner.

### Technical Idea 3

A vehicle system is mounted on a vehicle (1, 1A, 1B) that is allowed to participate in open road traffic. The vehicle system includes at least one processor (57b) for conducting a test related to the vehicle. The at least one processor executes: determining one or more metrics and a threshold thereof, monitoring the one or more metrics and determining, based on a relationship between the one or more metrics and the threshold, whether to enable an individual stop functionality of individually stopping the test in a vehicle unit, and transmitting, to a server (96) configured to perform overall management of the test, information indicating that the individual stop functionality is enabled.

According to such a technical idea, in each vehicle system, whether to individually stop the test is determined using the metric. Therefore, even when there is a stop reason with high urgency, the test can be stopped quickly in the vehicle unit. When the test is stopped individually, the information is sent to the server. Therefore, the server can objectively manage the test process.

### Technical Idea 4

A server is communicably connected to each of vehicle systems (2, 2A, 2B), in order to test the vehicle system mounted on multiple vehicles (1, 1A, 1B) that are allowed to participate in open road traffic. The server includes at least one processor (96b). The at least one processor executes receiving, from the vehicle, information indicating that an individual stop functionality of individually stopping a test in a vehicle unit by self-diagnosis is enabled, and determining, based on a situation of the individual stop functionality being enabled in each of the vehicles, whether to enable an overall stop functionality of stopping the test as a whole.

According to such a technical idea, in each vehicle, whether to individually stop the test is determined by self-diagnosis using the metric, and in the server, whether to stop the test as a whole is determined based on the situation of the multiple vehicles. The test can be stopped in an appropriate form by determining the stop functionality stepwise in this manner.

### Technical Idea 5

A notification control device is mounted on a vehicle (1, 1 A, 1B) capable of participating in open road traffic. The notification control device includes at least one processor (57b) in order to control issuance of a notification regarding a test related to the vehicle. The at least one processor refers to a condition for individual stop in which the vehicle individually stops the test, and determines whether the condition for the individual stop is satisfied in a short time. When it is determined that the condition for the individual stop is satisfied in a short time, before control of the vehicle that causes the condition for the individual stop to be satisfied is executed, the at least one processor performs adjustment such that the notification related to the stop of the test is sent toward a vehicle user.

According to such a technical idea, before the control of the vehicle that causes the individual stop condition to be satisfied is executed, the adjustment is conducted such that the notification regarding the stop of the test is sent to the vehicle user. With this adjustment, the vehicle user can perceive the stop of the test before the test has to be stopped, and therefore, the validity of the test process can be improved.

### Technical Idea 6

A notification control device is mounted on a vehicle (1, 1A, 1B) capable of participating in open road traffic. The notification control device includes at least one processor (57b) in order to control issuance of notification regarding a test related to the vehicle. The at least one processor executes, when the vehicle stops the test conducted during manual driving, determining whether the vehicle is traveling, and conducting, based on the determination, notification regarding the stop of the test at a timing at which traveling of the vehicle is avoided.

According to such a technical idea, when the vehicle stops the test, the notification regarding the stop of the test is conducted at a timing at which the traveling of the vehicle is avoided. The notification is issued at a timing at which the vehicle user is likely to concentrate, and therefore, it is easier for the vehicle user to perceive the notification.

1. A test system for testing a vehicle system mounted on each of one or more vehicles that are allowed to participate in open road traffic, the test system comprising:
at least one processor with a memory storing computer program code,
wherein
the at least one processor with the memory is configured to set and conduct a test, and
the at least one processor has both (i) an individual stop functionality for individually stopping the test in a participation unit in a standby-ready state or a conduction state of the test and (ii) an overall stop functionality for stopping the test as a whole in the standby-ready state or the conduction state of the test.

2. The test system according to claim 1, wherein
the test involves changing of software used in the vehicle system, and
the at least one processor with the memory is further configured to:
manage application of the software to the vehicle system;
rewrite, in the standby-ready state, conventional software, which has been applied to hardware of the vehicle system corresponding to the participation unit, to test software, which is downloaded from a server to the vehicle system; and
download the conventional software from the server and write the test software back to the conventional software in a case where the participation unit individually stops the test using the individual stop functionality.

3. The test system according to claim 1, wherein
the test involves changing of software used in the vehicle system, and
the at least one processor with the memory is further configured to:
manage application of the software to the vehicle system;
download, in the standby-ready state, test software, which corresponds to the participation unit, from a server and store in hardware of the vehicle system separately from conventional software;
cause both the conventional software and the test software to remain in the hardware with one or both of the conventional software or the test software being in a ready to be enabled state; and
in response to the participation unit stopping the test, enable the conventional software and disable the test software while remaining both the conventional software and the test software in the hardware.

4. The test system according to claim 1, wherein,
in a case where the individual stop functionality is enabled in the standby-ready state, in response to receiving, from the participation unit, an operation indicating an intention to participate in the test through a human machine interface device, the at least one processor with the memory is configured to stop the test of the participation unit without starting the test until elapse of a grace period during which the operation indicating the intention to participate in the test is cancellable.

5. The test system according to claim 1, wherein
the at least one processor with the memory is further configured to:
acquire consent from the participation unit that participation in the test is not cancellable during a predetermined period; and
fix the individual stop functionality for the participation unit to a disabled state during the predetermined period.

6. The test system according to claim 1, wherein
the one or more vehicles are multiple vehicles, and
the at least one processor with the memory is further configured to:
set a conduction area of the test; and
when a specific vehicle among the multiple vehicles moves out of the conduction area during the conduction state, stop the test of the participation unit corresponding to the specific vehicle individually using the individual stop functionality.

7. The test system according to claim 1, wherein
the one or more vehicles are multiple vehicles, and
the at least one processor with the memory is further configured to:
set an individual stop condition and an overall stop condition in the test;
when a specific vehicle among the multiple vehicles satisfies the individual stop condition, individually stop the test of the participation unit corresponding to the specific vehicle using the individual stop functionality; and
stop the whole test using the overall stop functionality when the overall stop condition is satisfied.

8. The test system according to claim 7, wherein
the overall stop condition is satisfied when, among the multiple vehicles, the number of vehicles or a proportion of vehicles, in each of which the test is individually stopped, is equal to or greater than a predetermined threshold.

9. The test system according to claim 1, wherein
the at least one processor with the memory is further configured to:
set an individual stop condition in the test; and
perform an adjustment such that a notification indicating stop of the test is output to a vehicle user before an execution of vehicle control, which causes the individual stop condition to be satisfied.

10. The test system according to claim 1, wherein,
when the participation unit stops the test, the at least one processor with the memory is further configured to output a notification indicating stop of the test at a timing by avoiding a traveling state of one of the one or more vehicles, which corresponds to the participation unit.

11. The test system according to claim 1, wherein
the at least one processor with the memory is further configured to:
provide a user interface that allows a vehicle user to set a mode of temporary stop for the test on the participation unit; and
determine, based on setting of the user interface, whether to enable the individual stop functionality.

12. The test system according to claim 11, wherein
the at least one processor with the memory is further configured to output a reminder notification for reminding the vehicle user of presence of the test when a duration of the temporary stop, which is defined in the setting of the user interface, exceeds a preset period.

13. The test system according to claim 1, wherein
the one or more vehicles each is a service vehicle that provides a service to a passenger,
the test is conducted on, as the participation unit, a passenger unit corresponding to the passenger, and
the at least one processor with the memory is further configured to enable the individual stop functionality for the passenger unit for which an intention to reject the test is confirmed, and provides a functionality of the test for the passenger unit for which the intention to reject the test is not confirmed.

14. A test method for testing a vehicle system mounted on each of multiple vehicles that are allowed to participate in open road traffic, the test method comprising:
determining, in each of the multiple vehicles, whether to enable an individual stop functionality that stops a test for one or more individual vehicles among the multiple vehicles by using one or more metrics; and
determining, based on a situation of the individual stop functionality being enabled in the one or more individual vehicles, whether to enable an overall stop functionality that stops the test for all of the multiple vehicles.

15. A software management device for managing software used in a vehicle system, the software being used to test the vehicle system mounted on each of one or more vehicles that are allowed to participate in open road traffic, the software management device comprising:
at least one processor with a memory storing computer program code, wherein the at least one processor with the memory is configured to:
download, in a standby-ready state of a test, test software from a server and store in hardware of the vehicle system separately from conventional software;
cause both the conventional software and the test software to remain in the hardware with one or both of the conventional software or the test software being in a ready to be enabled state; and
when a specific vehicle, which is one of the one or more vehicles equipped with the vehicle system, stops the test, enable the conventional software and disable the test software while remaining both the conventional software and the test software in the hardware.
